(19) United States
(12) Patent Application Publication
(10) Pub. No.: US 2023/0416096 A1
(43) Pub. Date: Dec. 28, 2023

(54) METHOD

(71) Applicant: Q-FLO LIMITED, Sevenoaks (GB)

(72) Inventors: Liron ISSMAN, Cambridge, Cambridgeshire (GB); Adam BOIES, Cambridge, Cambridgeshire (GB); Jeronimo TERRONES, Cambridge, Cambridgeshire (GB); Brian COLLINS, Ely, Cambridgeshire (GB); Fiona SMAIL, Cambridge, Cambridgeshire (GB); Philipp KLOZA, Cambridge, Cambridgeshire (GB); James ELLIOTT, Cambridge, Cambridgeshire (GB); Shuki YESHURUN, Haifa (IL); Meir HEFETZ, Harashim (IL); Martin PICK, High Melton, South Yorkshire (GB)

(73) Assignee: Q-FLO LIMITED, Sevenoaks (GB)

(21) Appl. No.: 18/247,374

(22) PCT Filed: Oct. 15, 2021
(86) PCT No.: PCT/GB2021/052675

§ 371 Date: Mar. 30, 2023

(30) Foreign Application Priority Data
Oct. 15, 2020 (GB) 2016334.1

(51) Int. Cl. C01B 32/164; C01B 32/162; B01J 19/08

(52) U.S. Cl. CPC C01B 32/164; C01B 32/162; B01J 19/087; C01B 2202/36; C01B 2202/08; C01P 2004/03; C01P 2006/40; C01B 2202/22; B01J 2219/00132

(57) ABSTRACT

The present invention relates to a method for the production of a carbon nanotube structure which has substantially aligned carbon nanotubes (CNTs) and to a temperature-controlled flow-through reactor.

The present invention relates to a method for the production of a carbon nanotube structure which has substantially aligned carbon nanotubes (CNTs) and to a temperature-controlled flow-through reactor.

There is increasing demand for lightweight materials with high strength and stiffness, especially when combined with high electrical and thermal conductivity. Products formed from aggregates of CNTs have been manufactured but their properties fall short of their theoretical capabilities. A major reason for this shortfall is imperfect alignment of the molecular scale CNTs within the macroscale fibres produced by their aggregation.

CNTs are molecular-scale structures comprising sheets of carbon atoms linked by covalent bonds and formed into closed tubes. The wall of a CNT may consist of a single layer (a single-walled CNT (SWCNT)) or multiple layers (a multi-walled CNT (MWCNT)). Individual CNTs have diameters typically between 0.4 nm and 40 nm and lengths typically more than 100 times their diameter.

To form CNTs into structures such as fibres or mats for macroscale applications it is necessary to create an aggregation of large numbers of CNTs. When brought into close proximity, CNTs are attracted to each other by van der Waals forces and other atomic and molecular-level interactions. A method for the formation of multiple long fine strands each comprising very large numbers of CNTs is known as floating catalyst chemical vapour deposition (FCCVD). In this method a carbon-rich feedstock (for example methane or acetylene), together with catalytic precursors containing iron and sulphur (such as ferrocene and thiophene respectively) are introduced into a ceramic tube and raised to a very high temperature (typically exceeding 1000° C.). Following decomposition, the carbon atoms provided by the precursor form an aerogel which can be extracted from the ceramic tube to form a fibre or mat. FCCVD and an arrangement of equipment is disclosed in EP-A-3227231. In practice, it is found that the alignment of the CNTs forming the aerogel is poor. This results in the mechanical, electrical and thermal properties of the fibres falling far short of the values that could be obtained from bundles of well-aligned CNTs.

The essential elements of a conventional FCCVD temperature-controlled flow-through reactor are shown schematically in FIG. 1. An electrically insulating refractory tube 1 is positioned axially within and surrounded by a furnace comprising a metallic outer case 2, thermal insulation material 3 and elongate electrical heating elements 4. After heating the furnace to a typical temperature of 1300° C., feedstock such as methane and catalytic precursors such as ferrocene and thiophene are fed into the input end 5 of tube 1 with a carrier gas such as hydrogen. An important function of the carrier gas is to exclude oxygen from the interior of the tube 1 which would otherwise cause the combustion of forming CNTs. Catalytic reactions occur at high temperature and result in the formation of a network of fibres each comprising bundles of CNTs in the form of an aerogel sock 6. The aerogel sock 6 is withdrawn from the output end 7 of the tube 1 where it may be stretched into a single fibre by winding onto a reel 8. Post-processing by (for example) twisting or treatment with acid serves to enhance the mechanical properties of the resulting fibre. Examples of such processes are described by Lee et al, “Direct spinning and densification method for high-performance carbon nanotube fibres”, Nature Communications, Vol. 10, Article 2962 (2019) and by J Bulmer et al, “Extreme stretching of high G:D ratio carbon nanotube fibres using super-acid”, Carbon, 153 725-736. An advantageous aspect of the FCCVD temperature-controlled flow-through reactor is that it can be used for continuous production. Precursor materials are continuously fed into the input end of the temperature-controlled flow-through reactor and the aerogel is discharged continuously from the output end.

Methods for the production of short well-aligned CNT fibres are known but are unsuitable for continuous production of long fibres. The use of electric fields has been reported (for example in CN-A-101254914) but in many instances these have been applied to very small-scale CNTs. Typical conventional arrangements comprise nano-scale channels or closely-spaced plates, each having a potential difference of a few volts applied across them. For example Chen et al, “Aligning single-wall carbon nanotubes with an alternating-current electric field”, Applied Physics Letters, Volume 78, No 23, June 2001 describes an arrangement of interdigitated electrodes spaced by approximately 25 μm and having an applied alternating voltage of 10 V peak-to-peak. Most investigators have described arrangements in which electric fields are applied to CNTs suspended in a liquid medium. While such arrangements cause CNTs to align, their motion in a liquid is slow and the field strengths that can be applied are limited by the properties of the liquid. Some investigators have applied alternating electric fields (see for example Liu et al, “Electric-field oriented carbon nanotubes in different dielectric solvents”, Current Applied Physics, Vol 4 (2004), pp 125-128). A method of alignment of CNT bundles growing orthogonal to the surface on which they formed is described by C Bower et al, “Plasma-induced alignment of carbon nanotubes”, Applied Physics Letters, Vol. 77 No 6, August 2000. Bower reported that in the presence of a field generated in a microwave plasma, nanotubes can be grown on contoured surfaces and aligned in a direction always perpendicular to the local substrate surface. This growth is analogous to a grass lawn with many closely-spaced fibres around 50 um long growing orthogonal to the surface on which they form. M. T. Cole and W. L. Milne, “Plasma Enhanced Chemical Vapour Deposition of Horizontally Aligned Carbon Nanotubes”, Materials, 2013, Volume 6, pp 2262-2273 also describe an arrangement employing a plasma to produce short aligned CNTs and observe that field strengths of the order of between 0.1 and 0.5 μV/m are required.

There has also been reported the growth of short aligned CNTs between a pair of plates across which a potential was applied (see for example Y. Avigal and R. Kalish, “Growth of aligned carbon nanotubes by biasing during growth”, Applied Physics Letters, 78, p. 2291-2293, 2001 and Q Bao and C Pan, “Electric field induced growth of well aligned carbon nanotubes from ethanol flames”, Nanotechnology 17 (2006) 1016-1021). A related arrangement is described by W. Merchan-Merchan et al, “Combustion synthesis of carbon nanotubes and related nanostructures”, Progress in Energy and Combustion Science, Vol. 36 (2010) pp 696-727.

The use of an alternating rather than static (DC) field was described by Chen et al “Quantitatively Control of Carbon Nanotubes Using Real Time Electrical Detection Dielectrophoresis Assembly”, Proceedings of the 15th IEEE International Conference on Nanotechnology, Jul. 27-30, 2015, Rome, Italy, pp 1029-1032.

A method for the creation of longer assemblages of CNTs was described by L. R. Bornhoeft et al (“Teslaphoresis of Carbon Nanotubes”, ACS Nano 2016, 10, 4873-4881, American Chemical Society). The method includes “explosive self-assembly” of powdered CNTs in air and slow alignment of a liquid CNT suspension.

US-A-2012/0282453 discloses a continuous method for producing a ribbon of CNTs which are aligned by applying a polymer spray to form a composite.

A combination of the use of FCCVD and the application of electric fields is described by Peng et al (Enrichment of metallic carbon nanotubes by electric field-assisted chemical vapor deposition, Carbon, Vol. 49 (2011), pp 2555-1560). However the electric field is oriented orthogonally to the direction of gas flow so continuous production of long aggregations of aligned CNTs is not possible.

None of the prior art methods is suitable for the production of continuous aligned macroscale fibres for engineering applications.

The present invention relates to a method and a temperature-controlled flow-through reactor by which CNT structures (eg fibres) may be manufactured continuously with improved alignment of the constituent CNTs which contributes to improved mechanical, electrical or thermal properties. In particular, the present invention relates to a floating catalyst (CVD) method in which there is direct interaction with the self-assembly of CNT bundles in the gas phase.

Thus viewed from a first aspect the present invention provides a method for the production of a carbon nanotube structure comprising:
(a) introducing a metal catalyst precursor into a continuous flow of a carrier gas in a temperature-controlled flow-through reactor;
(b) exposing the metal catalyst precursor in the flow of the carrier gas to a first temperature zone sufficient to generate particulate metal catalyst;
(c) releasing a source of carbon into the flow of the carrier gas;
(d) exposing the particulate metal catalyst and the source of carbon to a second temperature zone downstream from the first temperature zone, wherein the second temperature zone is sufficient to produce a carbon nanotube aggregate;
(e) generating an electric field in the temperature-controlled flow-through reactor at or near to the second temperature zone;
(f) discharging the carbon nanotube aggregate as a continuous discharge through a discharge outlet of the temperature-controlled flow-through reactor; and
(g) collecting the continuous discharge in the form of a carbon nanotube structure.

Typically the continuous flow of the carrier gas follows a substantially linear flow path.

Preferably the electric field is oriented substantially parallel to the flow path of the carrier gas. Particularly preferably the electric field is oriented substantially coaxial with the flow path of the carrier gas.

Preferably the temperature-controlled flow-through reactor comprises:
an elongate refractory housing extending from an upstream end to a downstream end into which the metal catalyst precursor is introduced in step (a) and the source of carbon is released in step (c);
a thermal enclosure surrounding the elongate refractory housing which is adapted to provide an axial temperature variation between temperature zones in the elongate refractory housing, wherein the temperature zones include the first temperature zone and the second temperature zone; and
an electrode positioned inside or outside the elongate refractory housing.

The electrode may be positioned partially inside the elongate refractory housing. For example, the electrode may extend upstream from the upstream end.

Preferably the electrode is oriented substantially parallel to the flow path of the carrier gas. Particularly preferably the electrode is oriented substantially coaxial with the flow path of the carrier gas.

The electric field may be generated by an electric field generator having a first terminal (eg a metal case) connected electrically to ground and a second terminal connected electrically to the electrode.

In step (a), the metal catalyst precursor may be introduced axially or radially into the temperature-controlled flow-through reactor. The metal catalyst precursor may be introduced through a probe or injector. The metal catalyst precursor may be introduced at a plurality of locations.

The metal catalyst precursor may be suspended in the carrier gas as solid particles (preferably solid nanoparticles).

The metal catalyst precursor may be a metal compound of at least one of the group consisting of Fe, Ru, Co, W, Cr, Mo, Rh, Ir, Os, Ni, Pd, Pt, Ru, Y, La, Ce, Mn, Pr, Nd, Tb, Dy, Ho, Er, Lu, Hf, Li and Gd.

The metal catalyst precursor may be a metal complex or organometallic metal compound.

Preferably the metal catalyst precursor is sulphur-containing.

The metal catalyst precursor may be introduced in step (a) together with a sulphur-containing additive. The sulphur-containing additive may be thiophene, iron sulphide, a sulphur-containing ferrocenyl derivative (eg ferrocenyl sulphide), hydrogen sulphide or carbon disulphide.

Typically the particulate metal catalyst is a nanoparticulate metal catalyst. Preferably the nanoparticles of the nanoparticulate metal catalyst have a mean diameter (eg a number, volume or surface mean diameter) in the range 1 to 50 nm (preferably 1 to 10 nm). Preferably 80% or more of the particles of the nanoparticulate metal catalyst have a diameter of less than 30 nm. Particularly preferably 80% or more of the particles of the nanoparticulate metal catalyst have a diameter of less than 12 nm. The concentration of the particulate metal catalyst may be in the range 10⁶ to 10¹⁰ particles cm⁻³.

In step (c), the source of carbon may be released axially or radially into the temperature-controlled flow-through reactor. The source of carbon may be introduced through a probe or injector. The source of carbon may be introduced at a plurality of locations.

The source of carbon may be an optionally substituted and/or optionally hydroxylated aromatic or aliphatic, acyclic or cyclic hydrocarbon (eg alkyne, alkane or alkene) which is optionally interrupted by one or more heteroatoms (eg oxygen). Preferred is an optionally halogenated C₁₋₆-hydrocarbon (eg methane, propane, ethylene, acetylene or tetrachloroethylene), an optionally mono-, di- or tri-substituted benzene derivative (eg toluene), C₁₋₆-alcohol (eg ethanol or butanol) or an aromatic hydrocarbon (eg benzene or toluene).

The generation of particulate metal catalyst may be initiated in step (b) by thermal decomposition or dissociation of the metal catalyst precursor into metal species (eg atoms, radicals or ions). The generation of particulate metal catalyst in step (b) may comprise nucleation of the metal species into nucleated metal species (eg clusters). The generation of particulate metal catalyst may comprise growth of the nucleated metal species into the particulate metal catalyst.

In a preferred embodiment, the carrier gas includes dispersed substrate particles. Typically the substrate particles are finely divided. The substrate particles serve to promote nucleation in the first temperature zone by forming substrate-supported particulate metal catalyst dispersed in the carrier gas. The substrate particles may be Si or SiO₂ particles.

Preferably the method further comprises introducing substrate particles into the continuous flow of the carrier gas.

In a preferred embodiment, steps (a) and (c) are concurrent.

The first and second temperature zones may extend over at least the range 600 to 1300° C.

The carrier gas is typically one or more of nitrogen, argon, helium or hydrogen. The flow rate of the carrier gas may be in the range 1000 to 50000 sccm (eg 30000 sccm).

The carbon aggregate may comprise multi-walled carbon nanotubes (eg double-walled carbon nanotubes) and/or single-walled carbon nanotubes.

The carbon aggregate may take the form of a 3D continuous network (eg an aerogel).

Preferably the carbon aggregate is an aerogel.

The carbon nanotube structure may be a powder, fibre, wire, film, ribbon, strand, sheet, plate, mesh or mat.

The carbon nanotube aggregate or carbon nanotube structure may comprise carbon nanotube bundles (ie arrays of substantially parallel CNTs (typically 3-20 CNTs) mutually attracted by Van-der-Waals forces).

The carbon nanotube aggregate or carbon nanotube structure may comprise carbon nanotube bundles with a median diameter (eg as measured by SEM and manual image analysis) of 16 nm or more, preferably 20 nm or more, particularly preferably 25 nm or more, more preferably more than 50 nm, even more preferably 75 nm or more. Preferably the diameter of the carbon nanotube bundles follows a log normal distribution.

The carbon nanotube aggregate or carbon nanotube structure may comprise carbon nanotube bundles with a median diameter (eg as measured by SEM and manual image analysis) which is variable axially (ie along the length). Preferably the diameter of the carbon nanotube bundles varies axially from a normal distribution to a log normal distribution.

Viewed from a further aspect the present invention provides a temperature-controlled flow-through reactor for the production of a carbon nanotube structure comprising:
an elongate refractory housing extending from an upstream end to a downstream end;
an inlet at or near to the upstream end of the elongate refractory housing for introducing a continuous flow of a carrier gas from the upstream end to and beyond the downstream end;
a first feed for releasing a source of carbon into the continuous flow of the carrier gas;
a second feed for introducing a metal catalyst precursor into the continuous flow of the carrier gas;
a thermal enclosure surrounding the elongate refractory housing which is adapted to provide an axial temperature variation between temperature zones in the elongate refractory housing, wherein the temperature zones include a first temperature zone sufficient to generate particulate metal catalyst and a second temperature zone sufficient to produce a carbon nanotube aggregate;
a collector for collecting from the downstream end a continuous discharge of the carbon nanotube aggregate in the form of a carbon nanotube structure;
a first electrode positioned inside or outside the elongate refractory housing; and
an electric field generator connected electrically between ground and the first electrode so as to apply a high potential thereto which is sufficient to generate an electric field in the elongate refractory housing at or near to the second temperature zone.

The temperature-controlled flow-through reactor may further comprise a second electrode. The electric field generator may be electrically connected to the second electrode so as to apply a high potential or a low potential thereto. Preferably the second electrode is electrically connected to ground.

The temperature-controlled flow-through reactor may further comprise a third electrode. The electric field generator may be electrically connected to the third electrode so as to apply a high potential or a low potential thereto. Preferably the third electrode is electrically connected to ground. The third electrode may be used to control the form, intensity and position of the electric field.

The temperature-controlled flow-through reactor may further comprise multiple additional electrodes which are positioned outside the elongate refractory housing. The multiple additional electrodes may be alternately connected to the electric field generator at a high potential and to ground.

The (or each) electrode may be an elongate electrode (eg an elongate solid or elongate hollow electrode). The (or each) electrode may be substantially cuboidal, cylindrical or annular. Typically the (or each) electrode is substantially coaxial with the elongate refractory housing.

The first electrode may be positioned at least partially inside the elongate refractory housing (eg at or near to the upstream end of the elongate refractory housing). The first electrode may be positioned at or near to (eg adjacent to) the second temperature zone. The first electrode may be positioned upstream from the second temperature zone.

The (or each) electrode is typically formed from a conductive material able to withstand the temperature and chemical environment inside the refractory tube. Suitable materials include molybdenum or vitreous carbon. The (or each) electrode may be equipped with an inert sleeve (eg an alumina sleeve). The sleeve may leave only the downstream tip of the electrode exposed.

Preferably the electric field is substantially coaxial with the elongate refractory housing.

Preferably the collector is electrically connected to ground. By virtue of its effective connection to the collector during use, the carbon nanotube aggregate is grounded.

In a first preferred embodiment, the first electrode is positioned inside the elongate refractory housing at or adjacent to the second temperature zone and the collector is connected electrically to ground. Preferably a grounded part (eg terminal) of the electric field generator is electrically connected to the collector.

In a second preferred embodiment, the temperature-controlled flow-through reactor further comprises a second electrode outside the elongate refractory housing and the first electrode is positioned inside the elongate refractory housing at or adjacent to the second temperature zone. Particularly preferably a grounded part (eg terminal) of the electric field generator is electrically connected to the collector.

In the second preferred embodiment, the second electrode may be electrically connected to the thermal enclosure and the thermal enclosure may be grounded. This serves to ground the second electrode. For example, the second electrode may be electrically connected to a metal case of the thermal enclosure.

In a third preferred embodiment, the first electrode is positioned outside the elongate refractory housing adjacent to the second temperature zone. Particularly preferably a grounded part (eg terminal) of the electric field generator is electrically connected to the collector.

In a fourth preferred embodiment, the temperature-controlled flow-through reactor further comprises a second electrode positioned outside the elongate refractory housing, wherein the first electrode is positioned outside the elongate refractory housing and the second electrode is electrically connected to ground.

In a fifth preferred embodiment, the temperature-controlled flow-through reactor further comprises a second electrode positioned inside the elongate refractory housing, wherein the first electrode is positioned inside the elongate refractory housing and the second electrode is electrically connected to ground.

The first electrode may be positioned adjacent to the second temperature zone. The tip of the first electrode may be positioned upstream of the midpoint of the elongate refractory housing.

The second electrode may be positioned adjacent to the second temperature zone. The tip of the second electrode may be positioned downstream of the midpoint of the elongate refractory housing.

Preferably the electric field generator applies an AC potential (eg in the range 500 V and 5000 V peak-to-peak).

Preferably the electric field generator is an AC source. An AC electric field serves advantageously to align continuously the CNTs in-situ before they form dense networks and an aerogel. Specifically an AC field produces a CNT stiffening effect (z-pinch) induced by a Lorentzian force. By way of illustration, it was determined in one example that CNT bundle diameters broadened from 16 to 25 nm and there was a dramatic increase in the electrical and tensile properties (up to 90 and 380% respectively) without modifying the fundamental nature of the constituent nano building blocks (as verified by Raman spectroscopy). The enhanced properties were correlated to the degree of CNT alignment within the textile as quantified by small-angle X-ray scattering and innovative SEM image analysis. Clear alignment (T₂=0.5) was achieved relative to the pristine material (T₂=0.2) at applied field intensities in the range 0.5-1 kV cm⁻¹.

Preferably the electric field generator applies an AC potential at a field intensity in the range 0.1 to 2.0 kV cm⁻¹, particularly preferably 0.5 to 1.0 kV cm⁻¹, more preferably 0.35 to kV cm⁻¹.

Preferably the electric field generator is operable at radio-frequency (RF). Particularly preferably the electric field generator is operable at high radio-frequency (HF) (for example a frequency in the range 10 to 20 MHz).

Preferably the temperature-controlled flow-through reactor further comprises a third feed for introducing substrate particles into the continuous flow of the carrier gas.

The first, second and third feed may be an injection nozzle, lance, probe or a multi-orificial injector (eg a shower head injector).

The elongate refractory housing may be substantially cylindrical (eg tubular).

Typically the thermal enclosure contains thermal insulation material. The thermal enclosure may be a metal case which is grounded.

The axial temperature variation may be non-uniform (eg stepped). The temperature of the temperature-controlled flow-through reactor may be controlled by resistive heating, plasma or laser.

The temperature-controlled flow-through reactor may be substantially vertical or horizontal.

The collector is typically electrically-conductive (eg metallic). The collector may be a rotary spindle, reel or drum.

The method and reactor of the invention facilitate control of the size and distribution of CNT bundles (ie arrays of substantially parallel CNTs (typically 3-20 CNTs) mutually attracted by Van-der-Waals forces) by (for example) adjusting electric field intensity.

Viewed from a yet further aspect the present invention provides a carbon nanotube aggregate or carbon nanotube structure which comprises carbon nanotube bundles with a median diameter (eg as measured by SEM and manual image analysis) of 16 nm or more, preferably 20 nm or more, particularly preferably 25 nm or more, more preferably more than even more preferably 75 nm or more.

Preferably the diameter of the carbon nanotube bundles follows a log normal distribution.

Viewed from an even yet further aspect the present invention provides a carbon nanotube aggregate or carbon nanotube structure which comprises carbon nanotube bundles with a median diameter (eg as measured by SEM and manual image analysis) which is variable axially along the carbon nanotube aggregate or carbon nanotube structure.

Preferably the diameter of the carbon nanotube bundles varies axially from a normal distribution to a log normal distribution.

The present invention will now be described in a non-limitative sense with reference to the accompanying Figures in which:

FIG. 1 shows a simplified view of a conventional FCCVD furnace for the production of carbon nanotubes in the form of an aerogel.

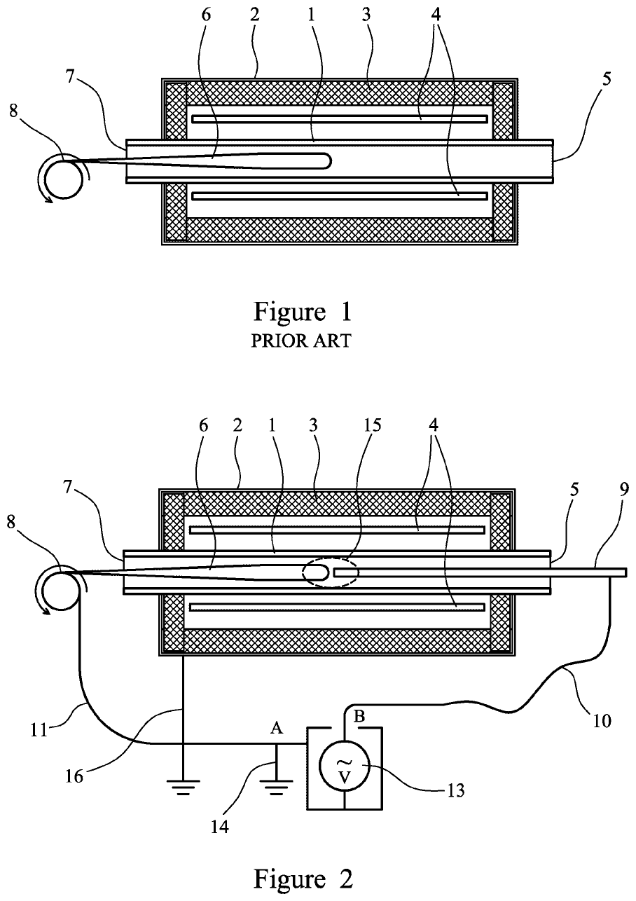

FIG. 2 shows a first embodiment of a temperature-controlled flow-through reactor of the invention having a first electrode contained within the refractory tube.

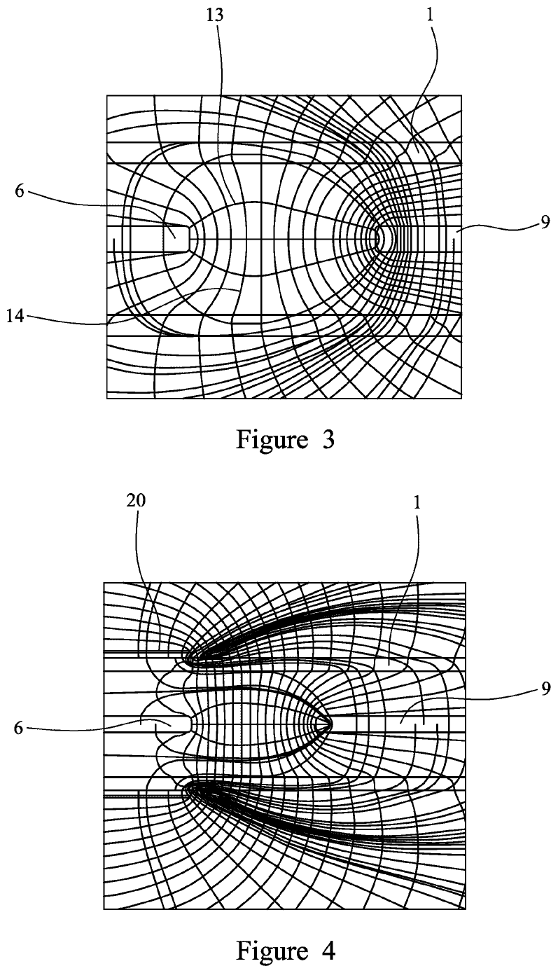

FIG. 3 shows the results of a computer simulation of an electric field generated in the first embodiment when a potential difference is applied between the first electrode and a second electrode formed by the aerogel.

FIG. 4 shows the results of a computer simulation of an electric field generated by a second embodiment of the temperature-controlled flow-through reactor of the invention when a potential difference is applied between the first electrode and the second electrode formed by the aerogel in the refractory tube which Is surrounded by a third hollow cylindrical electrode.

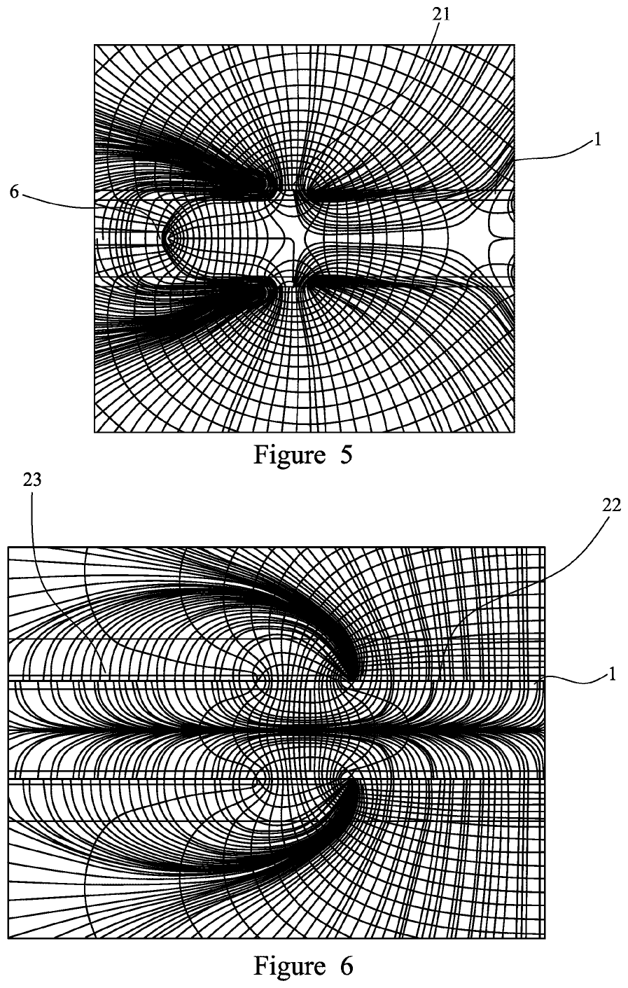

FIG. 5 shows the results of a computer simulation of an electric field generated by a third embodiment of the temperature-controlled flow-through reactor of the invention when a potential difference is applied between a hollow cylindrical first electrode external to the refractory tube and a second electrode formed by the aerogel.

FIG. 6 shows the results of a computer simulation of an electric field generated by a fourth embodiment of the temperature-controlled flow-through reactor of the invention when a potential difference is applied between two hollow cylindrical electrodes external to the refractory tube.

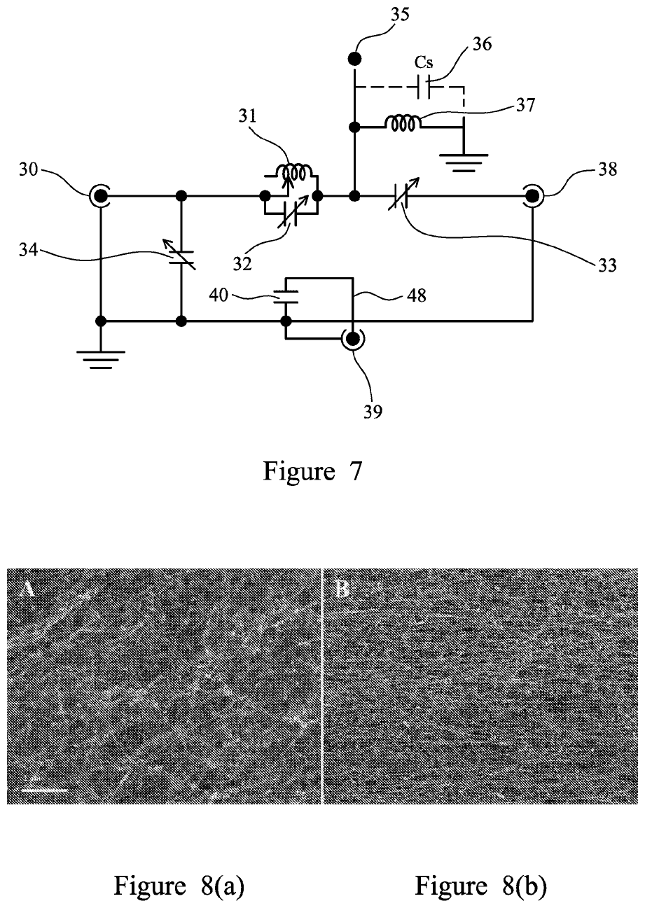

FIG. 7 is an exemplary embodiment of a circuit configured to be resonant at the selected operating frequency.

FIGS. 8a and 8b show SEM images of CNT aggregates formed with and without the application of an RF electric field.

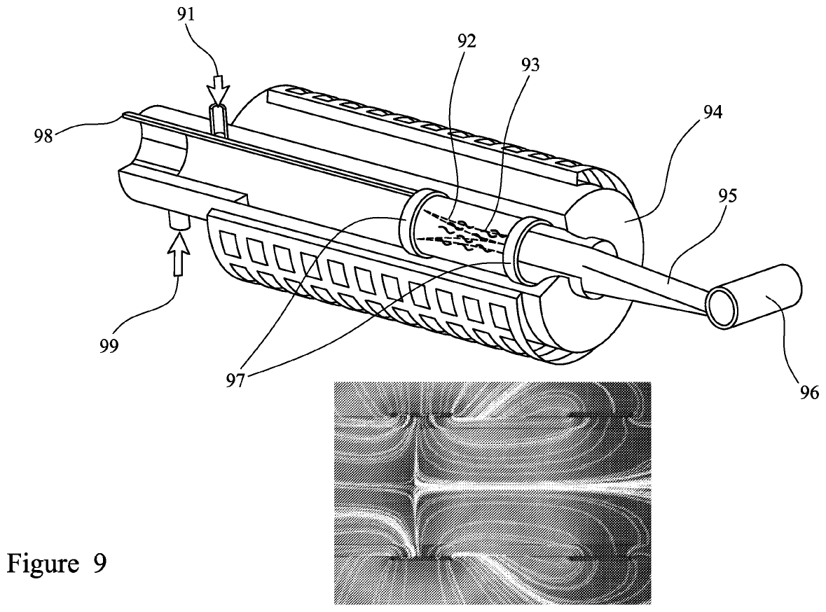

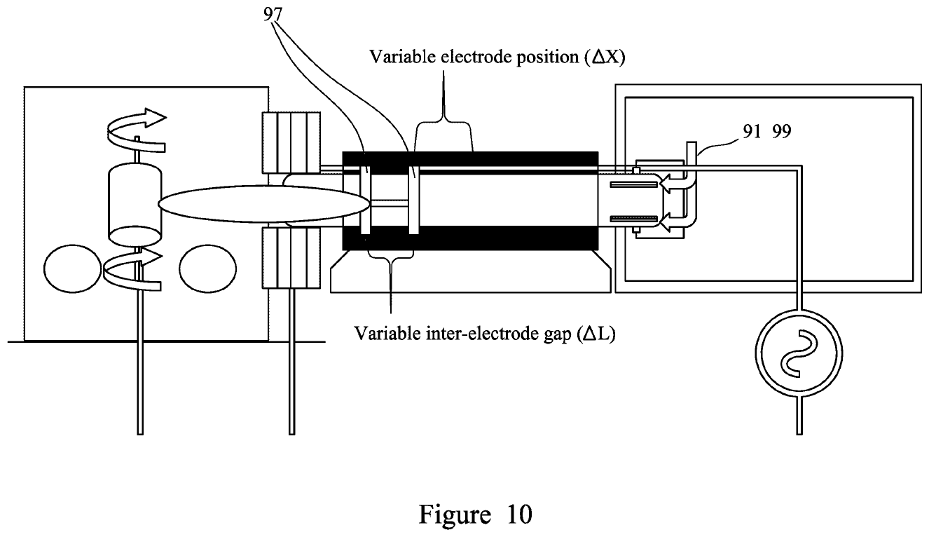

FIGS. 9 and 10 show respectively a perspective and cross-sectional view of an embodiment of a temperature-controlled flow-through reactor of the invention having external electrodes.

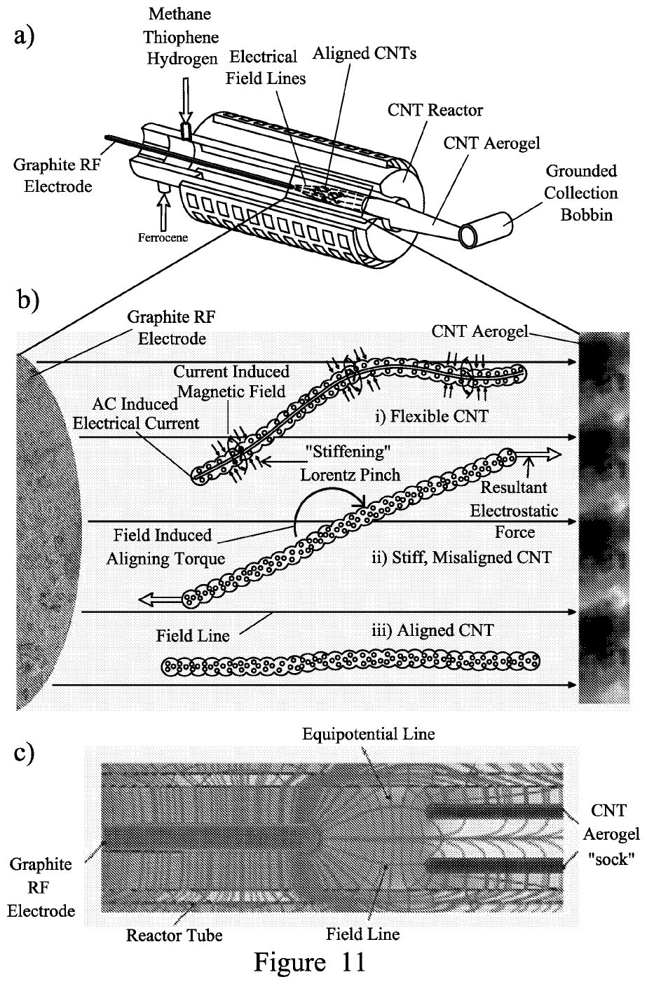

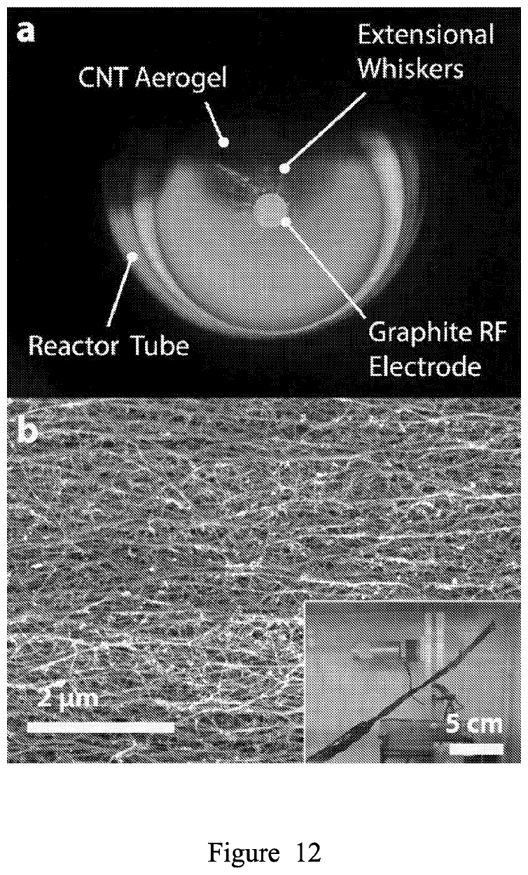

FIG. 11 shows an AC field alignment system. (a) An adapted FCCVD reactor with an RF electrode inserted at its front, whilst the forming CNT aerogel is collected on a grounded bobbin acting as a counter electrode. The CNTs align along the resultant field lines before forming the aerogel. (b) A zoomed schematic showing the occurrence in the inter-electrode gap. (i) The AC field induces a “Lorentz pinch” that stiffens the ultra-long CNT; (ii) The stiff, ultra-long CNT is under the influence of a field-induced aligning torque; (iii) The CNT is aligned according to the field lines; The schematic is not-to-scale, and i-iii co-occur. (c) FEM numerical results of the field distribution inside the reactor tube portraying equipotential lines (blue) and orthogonal field lines (red). The CNT aerogel (“sock”) was approximated as a 28 mm OD (25 mm ID) cylinder. The packing density of the equipotential lines indicates the local field intensity. The model shows the presence of alignment-inducing field lines bridging the two electrodes within the inter-electrode gap (50 mm wide).

FIG. 12 shows a continuous CNT alignment using an internal RF electrode. (a) An image taken from the reactor's end glancing upstream. The image shows CNT aerogel collection on a rotating bobbin while the AC field is applied. Extensional whiskers are “growing” from the end of the graphite RF electrode towards the forming aerogel. (b) SEM image showing the micro-morphology of the CNT end product. CNT alignment is apparent, although it does not seem optimal. Inset shows a 15 cm long, single CNT sock produced during AC alignment. The sock seems more rigid than usual and is able to support its weight.

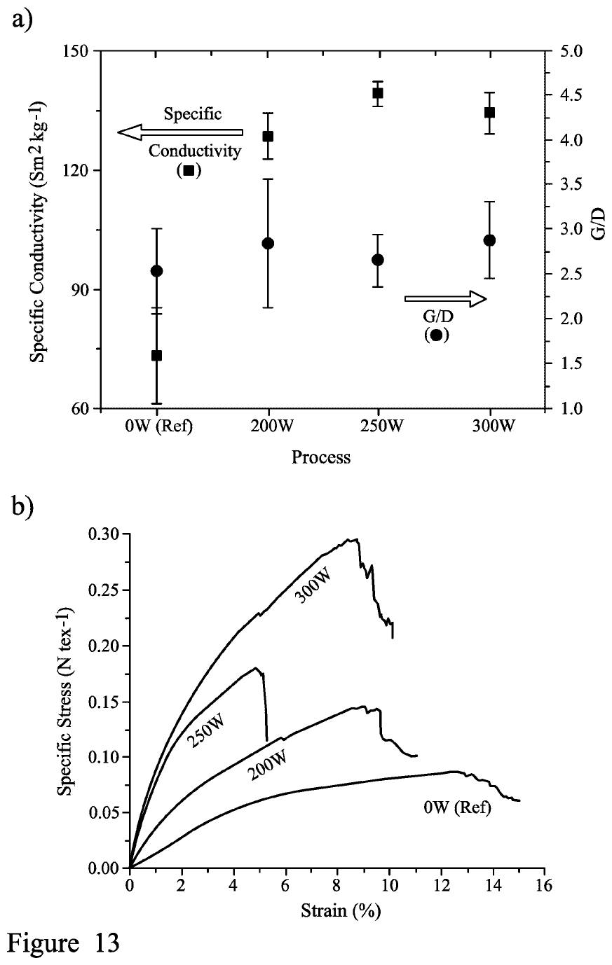

FIG. 13 shows the physical properties of CNT aligned materials. (a) A plot showing specific electrical conductivity (black, left axis) and G/D ratios (red, right axis) of CNT materials collected under different applied AC field intensities and a reference material (0W). While the G/D ratio has not changed significantly, the specific electrical conductivity increased by up to 90%. Error bars denote standard deviations using at least three different samples. (b) Stress-strain curves of tensile measurements showing a distinctive change in the mechanical performance from a ductile (0W) to a more brittle prone behaviour for aligned samples. The mechanical shift in properties correlates well with the applied field intensity (∝P½).

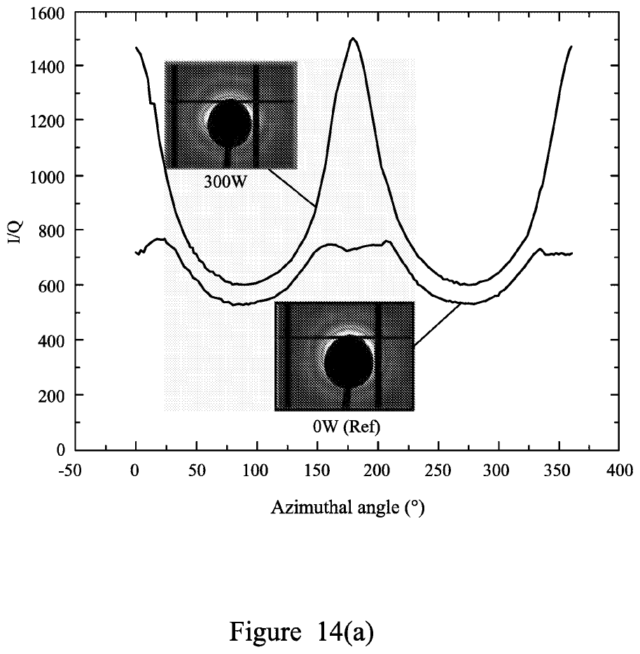

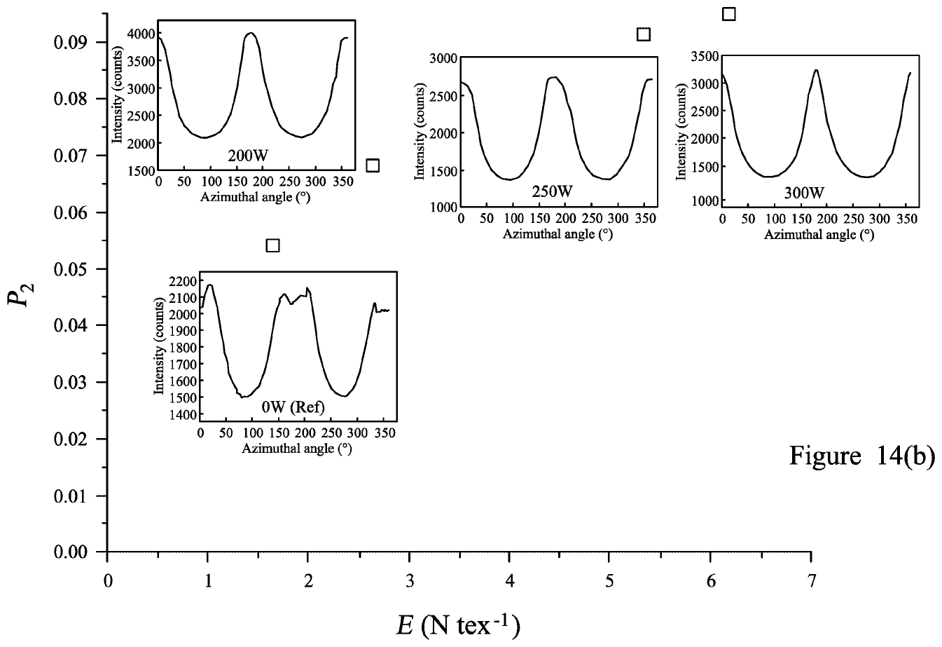

FIG. 14 shows WAXS orientation of CNT materials. (a) Intensity normalized azimuthal scans of the 0W (ref) and 300 W samples at Q range from 0.7 to 0.8 nm⁻¹. Azimuthal angle, ϕ=0° corresponds to the x-axis (equator) and perpendicular to the fibre axis. Insets show the corresponding 2D SAXS patterns. The reference material does not show any apparent scattering pattern, confirming the anisotropic nature of the textile. The 300 W sample shows a distinctive Lorentzian intensity distribution, confirming the presence of CNT alignment. (b) A plot showing Herman's parameter (P2) as calculated from the azimuthal scans (insets) as a function of the sample elastic moduli.

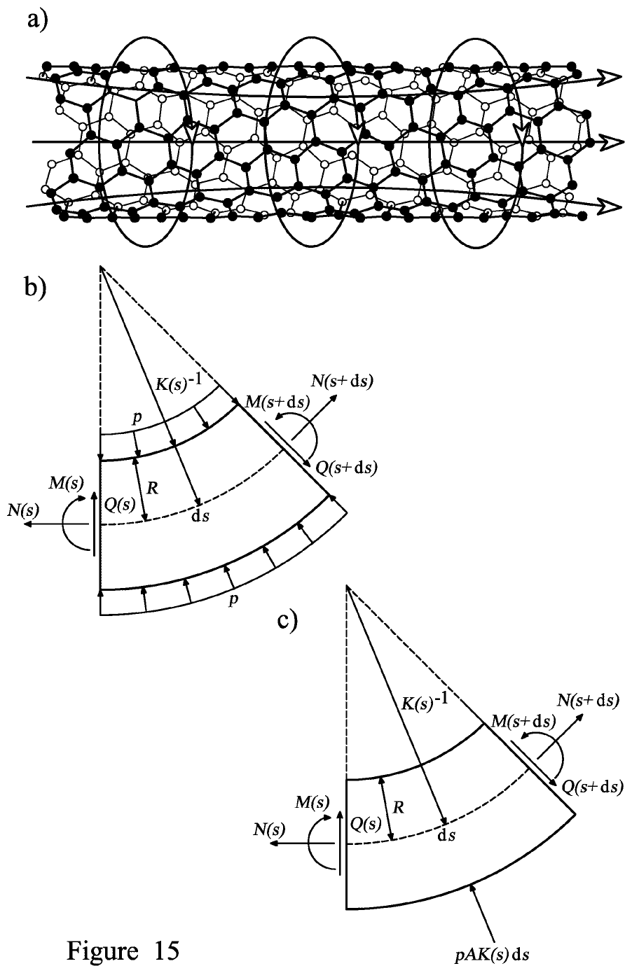

FIG. 15 is the z-pinch mechanism. (a) Illustration of electromagnetic fields in a CNT relevant for the z-pinch stiffening effect. Axial current (orange) is confined to the CNT walls and induces a circumferential magnetic field (blue). (b-c) Cross-section free-body diagram of the continuum CNT model for the z-pinch. Internal forces on both faces along the contour are shown in red. Pressure acting on CNT wall (b) and equivalent restoring force (c) are shown in blue.

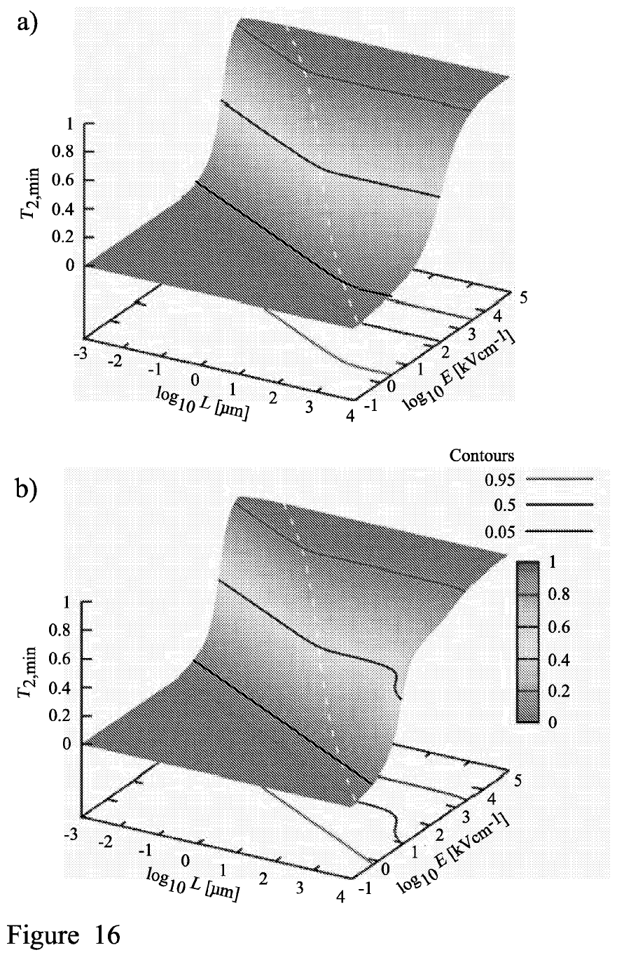

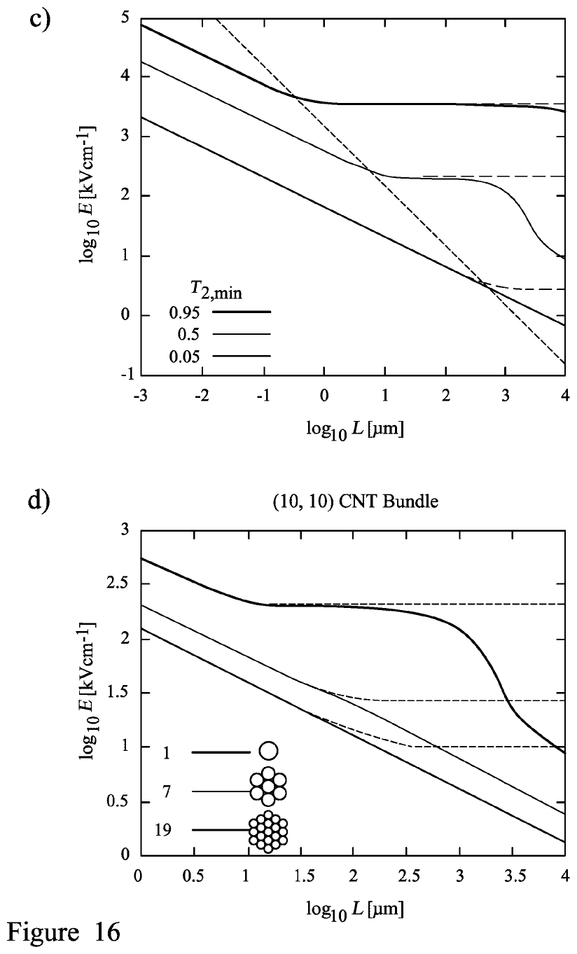

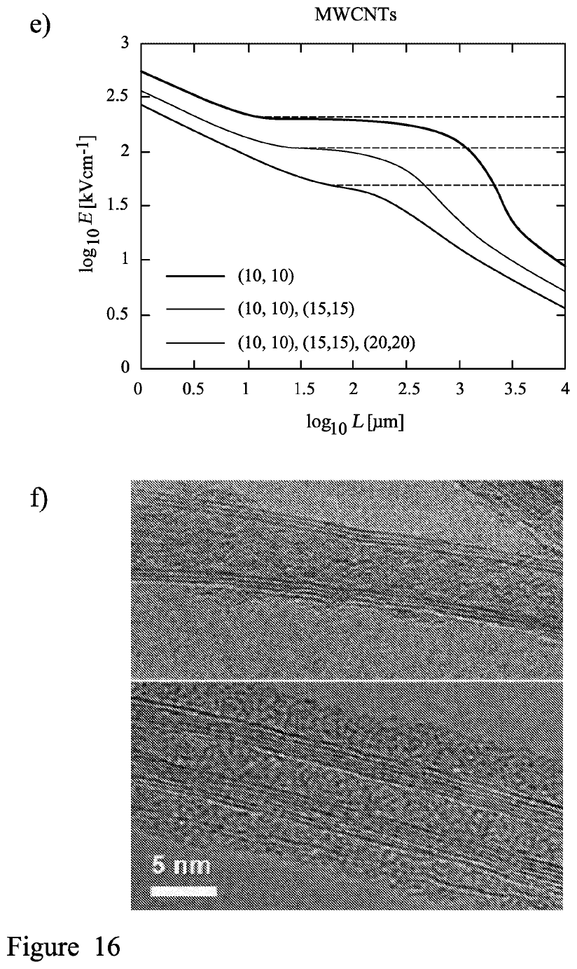

FIG. 16 shows modelling of CNT electric field alignment (a-b) Surface plot of T2_min versus CNT length (log) and electric field strength (log) for DC (a) and AC (b) electric fields. Contour lines at different values of T2_min are drawn in red, black and blue. Dashed white line indicates rigid-elastic transition for DC fields. (c) Log-log plot of electric field strength versus CNT length for contours taken from (a) (dashed) and (b) (solid). Dashed orange line shows rigid-elastic transition. (d-e) Log-log plot of electric field strength necessary to reach T2_min=0.5 versus CNT length for different (10, 10) SWCNT bundles (d) and MWCNTs with different armchair walls (e). (f) TEM images of a reference sample show the widespread presence of few walled MWCNTs with three to five walls (red lines).

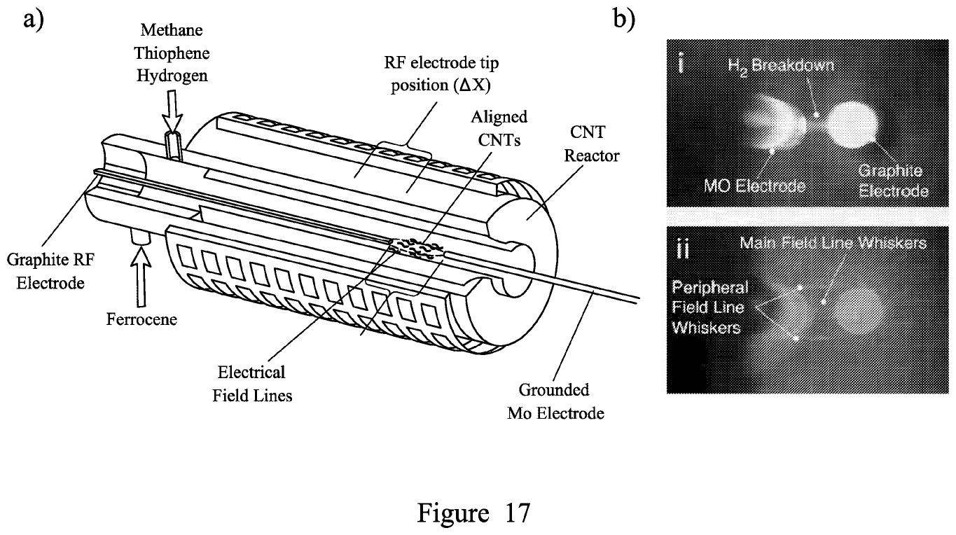

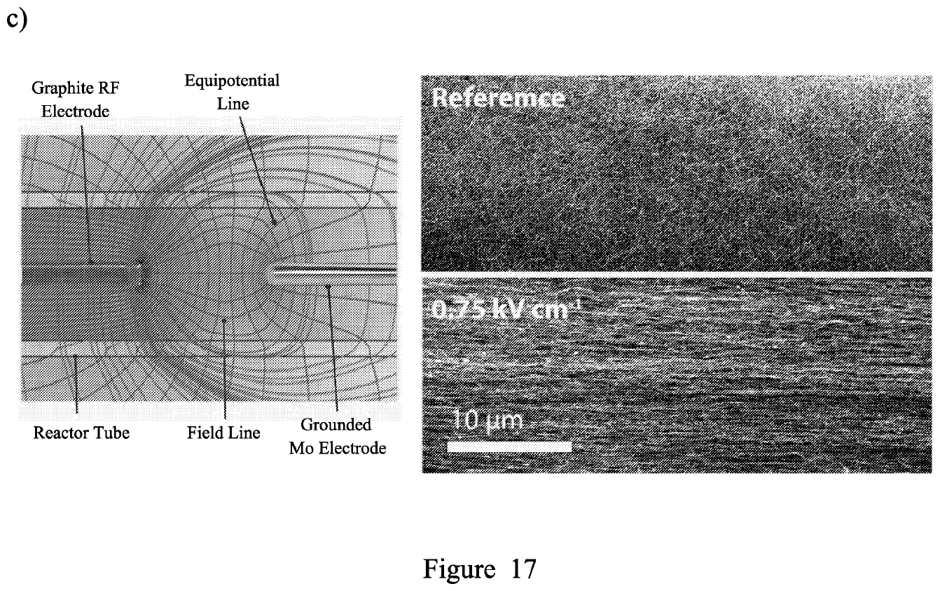

FIG. 17 shows a twin electrode configuration. (a) An RF electrode (graphite; 6 mm) inserted at the front and a grounded electrode (Mo; 6 mm) through the back. Both electrodes can run freely through the central axis, enabling control of the depth (ΔX) and width (ΔL) of the inter-electrode gap. The CNTs align along the resultant field lines. (b) A photo of the inter-electrode gap; (i) Hydrogen breakdown is witnessed due to the high field intensity (orders of at least several kV cm⁻¹); (ii) vapor-grown carbon fibre (VGCF) whiskers grow in the inter-electrode gap according to the bridging field lines between the electrodes. (c) FEM numerical results of the field distribution inside the furnace cavity portraying equipotential lines (blue) and orthogonal field lines (red). The packing density of the equipotential lines indicates the field's local intensity. The model shows an alignment-inducing field in a 50 mm inter-electrode gap similar to what is manifested in bii. (d) Low magnification SEM images showing the isotropic CNT network nature of a reference material (no voltage; top) in comparison to a highly aligned CNT micromorphology seen in a material produced under the influence of an applied field intensity of ^{˜}0.75 kV cm⁻¹ (bottom).

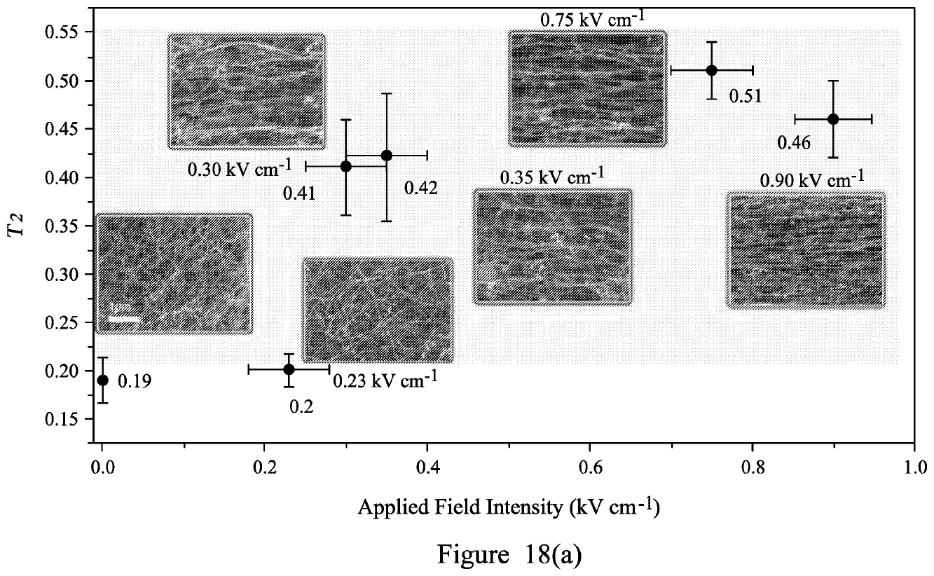

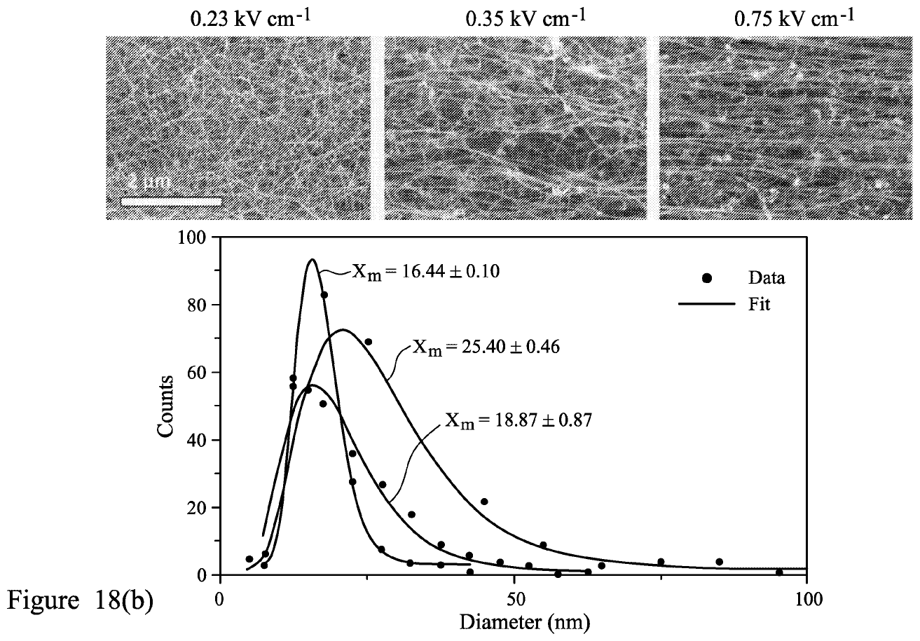

FIG. 18 shows image analysis of CNT materials. (a) A plot comparing the alignment portrayed by the Chebyshev orientational order parameter (T2) calculated by the Fibre COP software (accompanied by a typical SEM image) to the applied field intensity generated in the inter-electrode gap. While field intensities of less than 0.23 kV cm⁻¹ did not seem to affect the alignment, reaching field intensities of 0.3 kV cm⁻¹ and above showed a considerable increase in alignment. Y value variance is based on the standard deviation of calculated T2 values derived from at least three images of two different samples; X value variance is based on the voltage generated in two of the system's extreme setpoints. (b) Bundle diameter distribution (log-normal fitting) shows that the median bundle thickness transforms from 16.44±0.10 to 18.87±0.87 and 25.40±0.46 nm for a material produced at a field intensity of 0.23, 0.35 and 0.75 kV cm⁻¹ respectively. For each sample, 200 bundle diameters were manually measured.

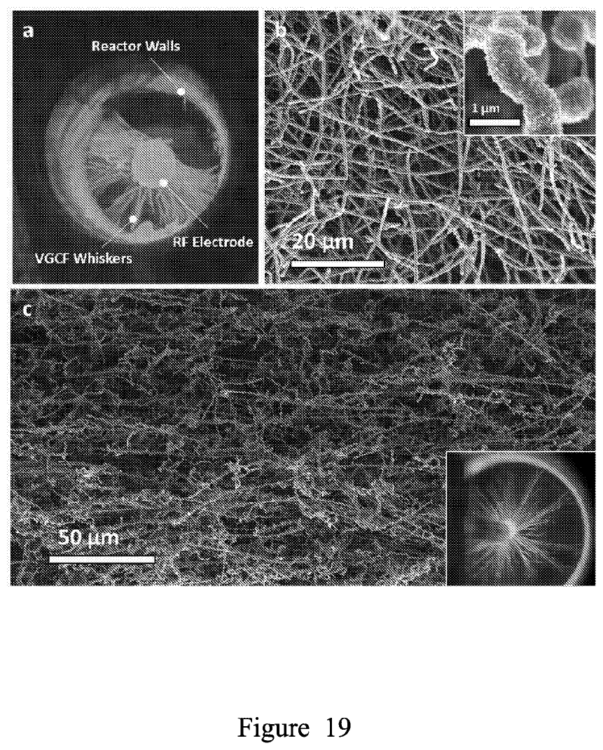

FIG. 19 shows VGCF formation in a FCCVD reactor. (a) VGCF whiskers radially grow from the RF electrode surface towards the reactor walls causing a short circuit. (b) SEM image of a whisker, revealing an isotropic network of VGCFs. Inset shows a single VGCF in a higher magnification. (C) SEM image of a whisker produced under the influence of the HV showing more alignment in the VGCF network. Inset shows that much finer “dendrite”-like whiskers are produced when the HV is applied during the whisker synthesis.

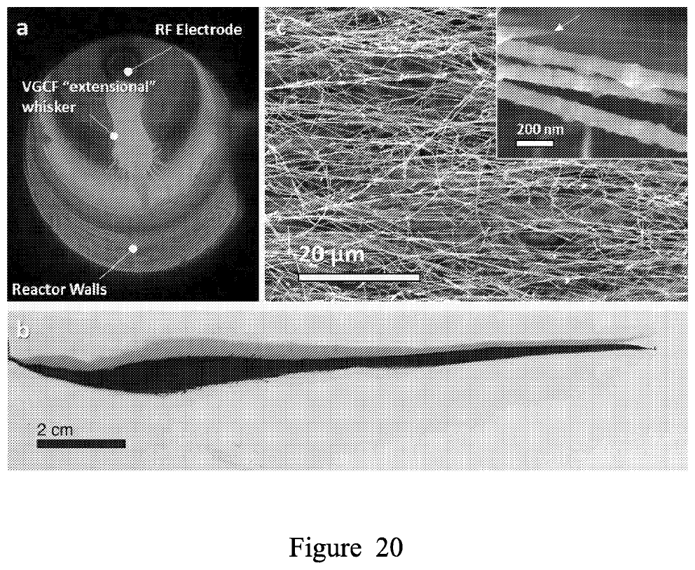

FIG. 20 shows VGCF “extensional” whisker growth in the FCCVD reactor. (a) VGCF whiskers axially growing from the RF electrode downstream, creating an extension to the RF electrode. (b) Some of the “extensional” whiskers grew to be 150 mm long. (c) SEM image of a VGCF “extensional” whisker, showing it was made of long, and aligned VGCFs. The inset shows a high magnification image revealing that the VGCFs are extremely thin (^{˜}100 nm in diameter) with a CNT core (arrow).

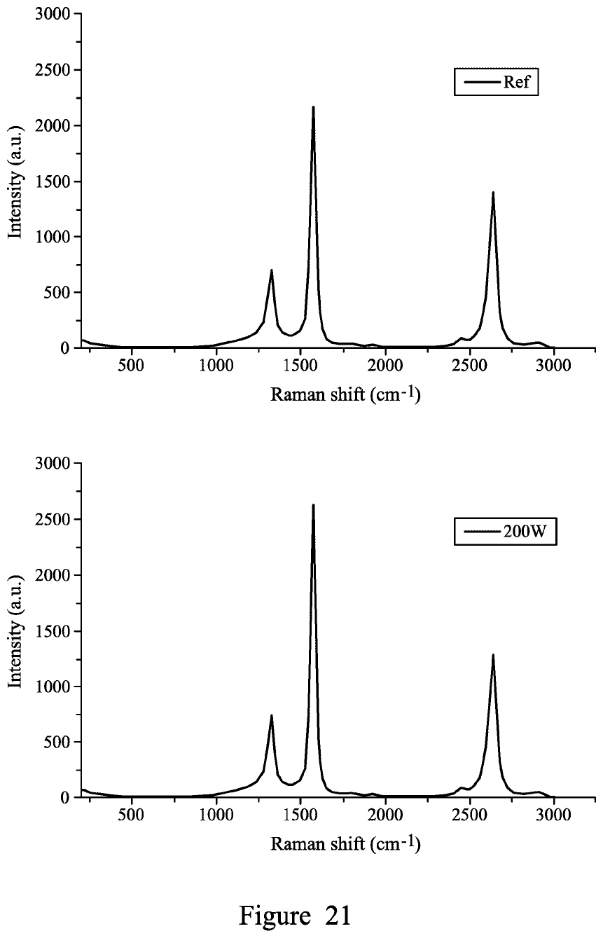

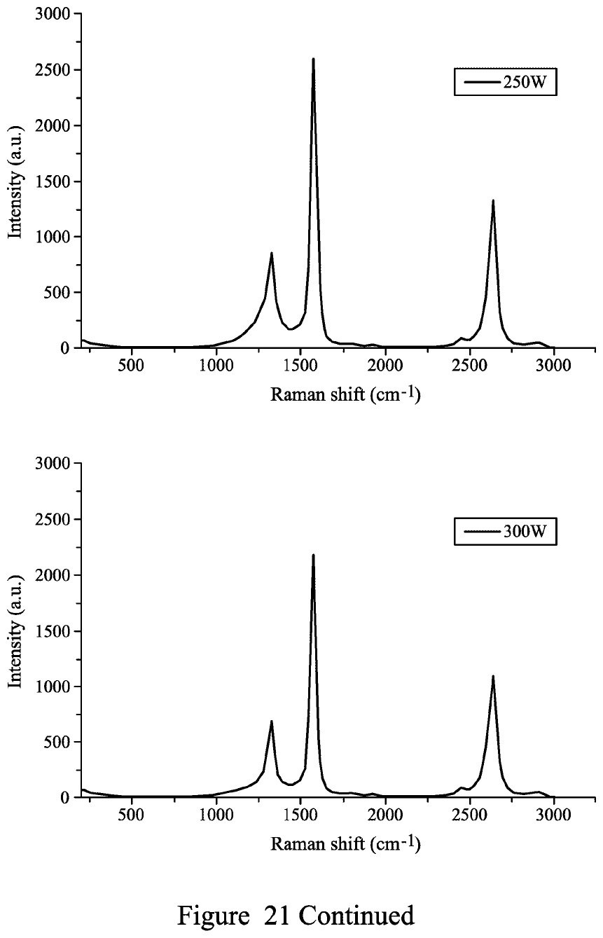

FIG. 21 are Raman spectra of various CNT samples produced by the internal RF electrode setup. There is no significant difference between the reference sample spectrum to the other spectra of materials produced under the influence of an electric field.

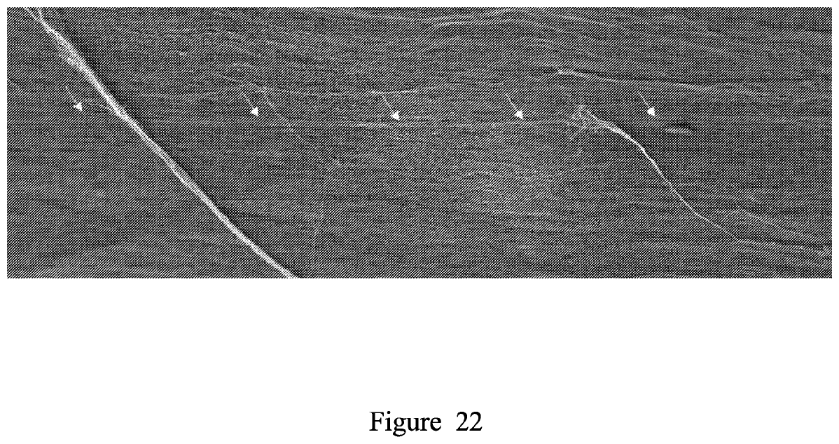

FIG. 22 is a SEM image of CNT material produced under a field intensity of 0.75 kV cm⁻¹. Arrows track the trajectory of an ultra-long CNT bundle measuring more than 100 μm in length.

FIG. 2 shows a first embodiment of a temperature-controlled flow-through reactor of the present invention. An elongate first electrode 9 is provided at an input end 5 of an electrically insulating refractory tube 1 positioned axially within and surrounded by a furnace. The furnace comprises a metallic outer case 2 which is grounded by a connector 16, thermal insulation material 3 and elongate electrical heating elements 4. The first electrode 9 is formed from a conductive material such as molybdenum able to withstand the temperature and chemical environment inside the refractory tube 1. A second electrode is formed by the trailing end of an electrically conductive aerogel sock 6 which is produced during processing and is discharged from an output end 7 of the refractory tube 1 onto a conductive reel 8. A first conductor 10 connects the first electrode 9 to a live terminal of a high-voltage source 13 and a second conductor 11 connects the conductive reel 8 to a terminal of the high-voltage source 13 which has a connection 14 to ground. The high voltage source 13 delivers a radio-frequency voltage. The effect of establishing a high potential difference (voltage) between the leading end of the first electrode 9 and the trailing end of the aerogel sock 6 is to create a substantially axial electric field in the region denoted by a dotted outline 15 which Is substantially aligned with the axis of the refractory tube 1.

FIG. 3 shows the results of a computer simulation of electric field lines 13 and equipotential lines 14 generated in the first embodiment between the first electrode 9 and the second electrode formed by the trailing end of the aerogel sock 6. It has been found that effective alignment of CNTs is observed by applying an alternating voltage at a frequency of 13.64 MHz This is a frequency allocated internationally for industrial and scientific use. The source of the applied potential is configured such that the applied potential is sufficient to provide the maximum degree of CNT alignment while avoiding arcing or corona discharge.

FIG. 4 shows the simulated electric field generated by a second embodiment of the temperature-controlled flow-through reactor of the invention between the first electrode 9, the second electrode formed from the aerogel 6 (as described for the first embodiment) and an elongate hollow cylindrical third electrode 20 external to the refractory tube 1. The third electrode 20 is maintained at ground potential by a conductive connection to the metallic (grounded) outer case 2 of the furnace. The second embodiment generates a more uniform axial field in the region between the first electrode 9 and the second electrode formed from the aerogel 6 than does the first embodiment.

FIG. 5 shows the simulated electric field generated by a third embodiment of the temperature-controlled flow-through reactor of the invention between a first electrode 21 which takes the form of an annulus or hollow cylinder surrounding the exterior of the refractory tube 1. In this embodiment, the first electrode 21 is at high potential and the second electrode formed from the aerogel 6 is grounded by the conductive reel 8 (as described for the first embodiment).

FIG. 6 shows the simulated electric field generated by a fourth embodiment of the temperature-controlled flow-through reactor of the invention between a first electrode 22 which takes the form of an elongate hollow cylinder and a second electrode 23 which similarly takes the form of an elongate hollow cylinder. The first electrode 22 is at high potential and the second electrode 23 is grounded. The first and second electrodes 22, 23 surround the exterior of refractory tube 1. The fourth embodiment generates a substantially axial electric field over a longer axial distance than the first, second and third embodiments.

In the embodiments of FIGS. 2 to 6, the metallic outer case 2 forms a grounded electromagnetic screen which shields the environment from radiation caused by the alternating fields inside the furnace. This ensures the safety of personnel as well as blocking interference with electrical or electronic equipment.

For a refractory tube 1 having a diameter of 55 mm, it was found that the voltage required to provide CNT alignment by alternating electric fields is typically between 500 V and 5000 V peak-to-peak. The maximum field strength that may be used is below that which causes the generation of corona discharges or the formation of a plasma within the refractory tube 1. The optimum axial position of the electrodes and the field strength between electrodes is a function of the diameter of the refractory tube 1, the identity and flow rate of reactive and transport gases within the refractory tube 1, the temperature profile along the axis of the refractory tube 1 and the configuration of the high-voltage electrode(s) and the grounded electrode(s). While the frequency of the applied field may be in the range 13.553-13.567 MHz, other frequencies may be used.

It is convenient to generate the electric field using a radio-frequency generator whose output is applied to a circuit arrangement configured to be resonant at the selected operating frequency. An exemplary embodiment of such a circuit arrangement is shown in FIG. 7 in which a radio-frequency power generator (provided with circuit arrangements including an oscillator and a power amplifier together with control and monitoring facilities) is connected by means of a radio-frequency transmission line to an input port 30. An inductor 31 and a variable capacitor 33 constitute a series resonant circuit whose function is to increase the voltage applied thereto from the input port 30. A connection is provided between an output port 35 and the junction of the inductor 31 and the variable capacitor 33 whereat the voltage applied at the input port 30 is multiplied by the voltage magnification factor (“Q-factor”) of the resonant circuit 31, 33. A variable capacitor 32 is connected in parallel with the inductor 31 to allow variation of the effective inductive reactance of the resonant circuit 31, 33. Selection of the values of the variable capacitors 32, 33 allows control of the Q-factor of the resonant circuit 31, 33 enabling control of the relationship between the voltage at the input port 30 and the output port 35. The inductor 31 may be provided with a variable tap to allow direct adjustment of its inductance. A variable capacitor 34 is provided to enable the input impedance of the circuit to be adjusted to match the 50 ohms impedance typically required by the connected radio-frequency generator. To permit the generation of high voltages (for example between 500 V and 10000 V) variable capacitors 32, 33, 34 are vacuum variable capacitors.

A stray (parasitic) capacitance 36 exists between the metallic outer case 2 of the furnace and the high voltage electrode and associated conductive connections. The effect of this stray capacitance is to load the resonant circuit 31, 33 resulting in reduced output voltage at the output port 35. The effect of the stray capacitance 36 may be reduced by connecting an inductor 37 in parallel therewith. The effective value of the inductor 37 Is chosen to create a parallel resonance with the stray capacitance 36 at the operating frequency.

A port 38 is connected by means of a radio-frequency transmission line to a resistive termination typically having a value of 50 ohms. A monitoring port 39 together with a galvanically connected conductive loop 48 and a capacitor 40 are provided to enable the output voltage to be measured after a one-time calibration process to relate the output voltage at the monitoring port 39 to a much lower voltage at the output port 35. After calibration, the voltage at the output port 35 may be estimated by measuring the low voltage at the output port 35 using (for example) a standard oscilloscope. This arrangement removes any requirement for frequent measurements of high radio-frequency voltages which may create hazards to personnel operating the equipment.

The radio-frequency generator connected to the input port 30 provides a selectable level of output power and contains arrangements to reduce output power in the event that the reflected power increases beyond a level that could create damage. Monitoring the reflected power provides an indication of changes within the reactor such as the incipient formation of corona or other electrical discharges or contact between the grounded CNT aerogel and the high voltage electrode. Monitoring information may be provided by a digital interface to the radio-frequency generator and may be used to control the rate of withdrawal of the aerogel from the refractory tube or the flow rates of reagents.

FIG. 8a is a scanning electron microscope image showing a sample of CNT aggregate produced using the temperature-controlled flow-through reactor of FIG. 1. The fibres formed from assembled CNTs show little degree of alignment. FIG. 8b is a scanning electron microscope image of a sample of fibres produced in the first embodiment of the invention with the application of an axial electric field at a frequency of 13.56 MHz. The temperature profile and other operating parameters were substantially unchanged. The fibres shown in FIG. 8b exhibit a significant degree of alignment.

FIGS. 9 and 10 show respectively a perspective and cross-sectional view of an embodiment of a temperature-controlled flow-through reactor 94 of the invention having Kanthal ring electrodes 97 and a Kanthal RF electrode 98 external to a refractory tube into which is fed methane/thiophene/hydrogen 91 and ferrocene 99. The external ring electrodes 97 produce electric field lines 92 to align CNTs 93 which form an aerogel 95 wound onto a bobbin 96. This facilitates a continuous process and eliminates the growth of unwanted VGCFs.

### EXAMPLE

### Methods

### High Voltage System and Final Element Modelling

A bespoke cabinet was fabricated to act as an RF shielded compartment for the HV components thereby ensuring personnel and equipment safety. The system housed a 300 W RF generator (Dressler Cesar 1312) working at the license-free 13.56-MHz band. The generator's output was connected to a 50-ohm load through a series-connected L-C circuit tuned to 13.56 MHz. Such an arrangement resulted in a high voltage being generated at the connection between the inductor and the capacitor. A second variable capacitor (C1) was connected in parallel with the inductor so its effective reactance could be varied. To project the system's generated HV into the reactor, the L-C junction was connected to an RF electrode. The voltage was tuned by modifying the reactance of the main capacitor and the parallel combination of the inductor and its capacitor according to equation (1):

$$Q = \sqrt{\frac{L}{C}} ∝ V \qquad ( 1 )$$

where Q is known as the voltage magnification factor, L is the inductance, C is the capacitance and V is the output voltage.

The RF output voltage was measured by connecting a resistive voltage divider (985 kΩ+1 kΩ) across the high voltage output of the network and measuring the voltage across the 1 kΩ resistor using an oscilloscope (72-8705A Tenma) and a 1:1 probe with 30 W applied input power. A correction was applied to account for the stated input impedance of the probe. As the output voltage is proportional to the square of the output power, the measurements at W were appropriately scaled

The field distribution inside the furnace was modelled using the AC/DC module of COMSOL Multiphysics. The small dimensions of the furnace interior (overall length 500 mm) compared with the free-space wavelength (22 m) allowed the field to be modelled on a quasi-DC basis. In such a model, the form of the electric field is independent of the applied voltage. The reactor component dimensions and material properties were faithful to the real-life system. The CNT aerogel seen in FIG. 11c was modelled as a cylinder with an OD of 28 mm (25 mm ID).

### Continuous CNT Alignment by a Single RF Electrode

The FCCVD reactor was equipped with a single RF graphite electrode aligned along the central axis of the tube. Conceptually the electrically conductive CNT aerogel forming at the end of the reactor acted as a grounded electrode (see FIG. 11a). The grounding of the CNT aerogel was assured by collecting it on a grounded bobbin which was earthed by a dedicated copper stake running through the ground. The RF electrode was connected to the HV system and was inserted into the reactor through a bespoke injector flange. The RF electrode tip was stationary and positioned 95 mm upstream to the reactor midpoint. The power supply of the HV unit was set to 0, 200, 250 and 300 W. Reflected power during the collection was minimal (<10 W). Each power configuration run was repeated at least three times. After the collection ended, the CNT material was manually rolled perpendicular to the collection axis to produce a “cigar-rolled” thin string on the bobbin's circumference. The string was cut at a random point to produce a ^{˜}160 mm long CNT fibre-like material. All runs employed the same process parameters as described for the CNT alignment by a twin electrode and collection speed was rounds per minute (linear speed of 0.157 m s⁻¹).

### CNT Fibre Characterization

Fibres were weighed using a microbalance (Sartorius SE2-F) and their length was measured to calculate the linear density of each sample in g km⁻¹ (tex). Fibre linear resistance was determined by measuring the resistance of a 100 mm section of each sample using a bespoke four-point probe jig connected to a milliohm meter (Aim-TTi BS407). Specific electrical conductivity was calculated by normalizing the linear conductance (inversely proportional to the linear resistance) according to the linear density of each sample. Specific electrical conductivity values (S m²kg⁻¹) were averaged according to a set of at least three samples.

Fibre tenacity (ultimate tensile stress normalized by linear density) and strain at failure were determined using an Instron mechanical tester (5500R) equipped with a 10 N load cell. The initial gauge length was 20 mm and the sample displacement rate was 1 mm min⁻¹. Sample pretension was fixed at 0.1 N. To prevent slippage, the ends of the CNT fibre samples were sandwiched and glued between aluminium foils before clamping to the grips. Fibre tenacity and strain at failure values were averaged according to a set of at least three samples.

Raman analysis was conducted in a Horiba XploRA PLUS confocal microscope system using a 638 nm laser, 50× objective, 1200 grating, 25% laser power and three accumulations of Spectra are presented with baseline correction applied. G/D ratios were averaged according to a set of at least three repeats on three different samples.

2D SAXS patterns of CNT materials were collected at ALBA synchrotron light facility (Barcelona, Spain) at BL11-NCD-SWEET non-crystalline beamline, equipped with Dectris (Pilatus 1M) photon counting and Rayonix LX255-HS CDD detectors. Scattering of the samples was collected using a microfocus spot of ^{˜}10-μm in diameter and at a radiation wavelength of λ=1.0 Å. Before collecting the patterns, the position of the sample holder was calibrated using silver behenate (AgBh). The collected patterns were first corrected for the background scattering and then analysed using DAWN software (v. 2.20) obtaining azimuthal profiles after radial integration over Q range of 0.7 to 0.8 nm-1. The intensities were normalized by the scattering invariant Q obtained from Kratky plots, q2·I(q) vs q.

For HRTEM imaging, specimens were prepared by sonicating ^{˜}10 mg of CNT material in 200 ml of 1-methyl-2-pyrrolidinone (NMP 99% purity; Merck) for 60 minutes in an ultra-sonicator (Hielscher, UP400ST). 1 ml of the dispersion was pipetted on a Lacey Formvar/Carbon TEM grid (Ted Pella) and was left undisturbed for 1 minute to be then blotted away. The residual NMP was dried by baking the grid in a vacuum oven at 70° C. overnight. Imaging was done in high-resolution mode using a monochromated FEI Titan 80-300 TEM operated at 300 KV.

### CNT Alignment by a Twin Electrode Setup

The FCCVD reactor was equipped with two electrodes aligned along the central axis of the 50 mm (OD) alumina tube (Almath Crucibles; see FIG. 17a). A 6 mm graphite electrode (Beijing Great Wall Co) referred to as the RF electrode was connected to the HV system and was inserted into the reactor through the injector flange. The injector flange enabled the free lateral movement of the RF electrode whilst two side ports were used to introduce the ferrocene from one port and the other precursors from the other. A 6 mm molybdenum electrode (Goodfellow) referred to as the grounded electrode was inserted from the far end of the reactor. To ease alignment of the electrode and fix its position, a grounded z-axis translation stage (Optics Focus Instruments Co) was used. To maximize the electric field homogeneity, both electrode tips were polished to produce hemispherical smooth ends. The experiments were run by varying discretely the inter-electrode gap (ΔL) between 200, 150, 130 and 50 mm. This was facilitated by changing the RF electrode tip position while the grounded electrode end was stationary (140 mm downstream to the reactor midpoint). The power supply of the HV unit was set to 300 W (highest output) except for ΔL=50 mm, in which a 0W (reference) and a 180 W power setting were also used. Each setup was run at least twice. All experiments were run for a short period (<5 s), as the process was immediately shutdown when the reflected power indicated by on the HV power source console reached its maximal capacity (100 W). In all runs (unless specified otherwise), the process ran as follows: the furnace was set to 1300° C., precursors included hydrogen (1400 standard cubic centimetres per minute; sccm, BOC); methane (160 sccm, BOC); ferrocene (200 sccm of hydrogen through a tank heated to 110° C., 98% purity Merck); and thiophene (60 sccm of hydrogen through an ice-slush cooled reservoir at ^{˜}0° C., ≥99% purity Merck).

### SEM Imaging and Image Analysis

The CNT specimens were imaged using a MIRA3 field emission gun-SEM (Tescan). Imaging was done at an acceleration voltage of 5 kV using the In-Beam SE detector at a 3-5 mm working distance. The specimens were not sputter coated. For alignment quantification, images were acquired at a 50k× magnification using a 4096×3072 raster. In case alignment was visually evident, images were manually taken at an angle that most CNTs were parallel to the long axis of the rectangular frame. At these imaging parameters, the resolution was calculated to be at 2.9-4.7 pixels per CNT bundle (based on the finding that the CNT bundles median diameter was between 16-26 nm as shown in the results section) and as such the number of CNTs per frame should be higher than 500. The resolution and number of CNTs per frame satisfied what was required for successful image analysis. SEM image analysis was performed to acquire the image orientational distribution function (ODF) and further extract the orientational order parameter (namely the second moment which is the average of the Chebyshev polynomial T2). The analysis was done by the use of the open-access Fibre COP program. The program parameters were set for 5 scans, bin size of 0.25, with a filter interval of 5. The number of peaks was set to 3, while each peak was Lorentzian fitted. Acquiring the average T₂ orientation parameter for each twin electrode setup was based on the analysis of at least 3 SEM images (a total of more than 1500 CNTs). SEM images for CNT bundle diameter analysis were taken using the same configuration as described above but with a 200k× magnification. 200 CNT bundle diameters were manually measured using Fiji, and the histogram was fitted by a log-normal distribution using OriginPro 2021.

### Modelling of CNT Alignment Under the Influence of an RF Field

CNT alignment with alternating electric fields can be described using the worm-like chain model with energy contributions from bending, electric polarization and the additional electromagnetic interactions due to the z-pinch stiffening effect.

Current, Pressure and Force

As a first approximation, any variation of the current magnitude in the CNT along its contour and in time was neglected. Hence a constant current J in the CNT is postulated. In the derivation of the Lorentz pressure, a continuous CNT with a finite wall thickness is assumed. Using Ampère's law, it is possible to compute the magnetic field strength inside the CNT wall. The axial electric current and circumferential magnetic field are shown in FIG. 14a. The magnetic field and the current in the CNT interact, leading to a uniform compressive Lorentz force on the CNT wall. By integrating over the width of the CNT and taking the limit of vanishing wall thickness, the Lorentz pressure acting on the CNT wall is equal to:

$$p = \frac{{μ}_{0} {J}^{2}}{8 {π}^{2} {R}^{2}} . \qquad ( 2 )$$

By further integrating over the surface at each point along the contour, parametrized by s, the following restoring line force density can be derived:

$$q ( s ) = pA \frac{d \hat{t} ( s )}{ds} , \qquad ( 3 )$$

were A=πR² is the cross-sectional area of the CNT and \hat{t}(s) is the tangent vector along the CNT. Hence the pressure resulting from the current will always work against the curvature of the chain. The pressure and restoring force are illustrated for a 2D continuum model of a CNT in FIG. 15b-c.

Energy Contributions

Using variational methods, the energy contribution of the restoring force density due to z-pinch stiffening is computed:

F_{q}=−pA[∫₀^{L/2}ds\hat{t}(0)·\hat{t}(s)+∫_{L/2}^{L}ds\hat{t}(L)·\hat{t}(s)] (4)

This energy has the natural interpretation of both halves of the chain being pulled in the direction of their respectively closest ends with the mid-point of the chain being fixed in place.

The current and the resulting pressure need to be externally induced in the CNT. This can be done by applying an electric field E across the CNT. Assuming a simple model where charges can only move tangentially within the CNT, the following energy contribution of the electric field itself has been proposed:

$${F}_{E} = - {\int }_{0}^{L} d s \frac{{ε}_{0} A}{2} {( \hat{t} ( s ) \cdot E )}^{2}$$

where A is again the cross-sectional area of the CNT.

Combining the energy terms discussed above with the regular curvature term of the WLC yields the full free energy functional of the model:

$$F [ \hat{t} ( s ) ] = {\int }_{0}^{L} d s [ \frac{a}{2} {( \frac{d \hat{t} ( s )}{ds} )}^{2} - \frac{{ε}_{0} A}{2} {( \hat{t} ( s ) \cdot E )}^{2} ] - \frac{{μ}_{0} {J}^{2}}{8 π} [ {\int }_{0}^{L / 2} d s \hat{t} ( 0 ) \cdot \hat{t} ( s ) + {\int }_{L / 2}^{L} ds \hat{t} ( L ) \cdot \hat{t} ( s ) ] ,$$

where α simply denotes the bending stiffness of the CNT.

Harmonic Approximation

For the present purposes, it is sufficient to assume that the CNT is already strongly aligned with the electric field. Without loss of generality, the electric field point is allowed along the z-axis and has magnitude E. The tangent vector and its derivative to second order in the x and y components of the tangent vector θ(s) may then be expanded to then arrive at the following harmonic approximation for the free energy, up to an additive constant:

$$F [ θ ( s ) ] = {\int }_{0}^{L} d s [ \frac{a}{2} {( \frac{d θ ( s )}{ds} )}^{2} + \frac{{ε}_{0} {AE}^{2}}{2} {θ ( s )}^{2} ] + \frac{{μ}_{0} {J}^{2}}{16 π} [ {\int }_{0}^{L / 2} d s {( θ ( s ) - θ ( 0 ) )}^{2} + {\int }_{L / 2}^{L} d s {( θ ( s ) - θ ( L ) )}^{2} ]$$

This approximate model is the basis for the present results and can be solved exactly using methods from Gaussian statistical field theory.

### Results and Discussion

### Continuous CNT Alignment Using an Internal RF Electrode

The field alignment adapted FCCVD rig used a graphite electrode (the RF electrode) which was connected to the HV unit and inserted through the reactor head. The electrically conductive CNT aerogel (continuously synthesized in the reactor) was collected on an earthed bobbin to act as the grounded electrode (see FIG. 11a). To minimize artifacts related to the mechanical winding speed, the bobbin's linear speed was set to ^{˜}0.16 m s⁻¹ which was considered as an inefficient velocity for CNT alignment. FIG. 11b portrays the mechanism of the inter-electrode alignment process. The alignment process is based on an internal AC current, z-pinch stiffening effect and an induced dipole aligning torque. From initial trials, it was seen that after the injection of the process precursors, there was a radial growth of whisker-like materials from the electrode surface outwards (see FIG. 19a). These whiskers grew in a section of the reactor, 70-90 mm upstream to its midpoint (equivalent to a temperature range of 1100-1200° C.). SEM analysis revealed that those whiskers were made from isotropic networks of submicron vapor-grown carbon fibres (VGCFs see FIG. 19b). These whiskers grew without the application of HV but with the presence of an electric field, an instant surge of whisker growth was noticeable once the precursors were injected. Under the influence of the field, it was evident that the VGCFs did not spontaneously self-assemble but aligned themselves according to the field lines (see FIG. 19c). In this configuration, some of the individual VGCFs showed lengths exceeding 100 μm. This preferential growth of aligned VGCF whiskers could be explained by a finite element field distribution model for the inner furnace cavity (see FIG. 11c). The model indicated that an intense radial field (represented by dense packing of blue equipotential lines) is located between the RF electrode and the alumina tube. This model also reassured the presence of well-defined field lines between the RF electrode and the CNT aerogel “sock”, enabling the CNTs to align accordingly.

Due to the rapid radial growth of VGCF whiskers on the RF electrode and the inevitable electrical contact with the ceramic tube, a low resistance was created within a few seconds between the RF electrode and the ground. This rendered the HV setup off-tune and led to a massive drop in voltage and field intensity. Due to this, the RF electrode was retracted 100 mm upstream of the midpoint. At this position, the RF electrode was at least 10 mm further upstream to where VGCF whiskers were detected growing, thus avoiding an RF short circuit during the continuous run. In such a setup, it was visually apparent that no radial growth of VGCF whiskers occurred during the runs but some axial whisker growth could be detected (see FIG. 12a). The CNT materials produced when HV was applied seemed more rigid than their references, as a single CNT sock could self-support without collapsing (see FIG. 12b). SEM imaging showed a pattern of CNT alignment. However it was not dominant. This was expected because the inter-electrode gap in such a configuration was vast, inversely reducing the applied field intensity. Nevertheless, as shown in FIGS. 12a and 20 a, it is hypothesized that due to the presence of an electrical field, whiskers self-assembled and laterally grew from the tip of the RF electrode thereby narrowing artificially the inter-electrode gap. Indeed some of those “extensional” whiskers grew up to 150 mm long and were made of well-aligned, extremely thin VGCFs (see FIG. 20c).

Trials with this setup were run with the RF power supply set to 0 (reference), 200, 250, and 300 W (maximal power output). In this setup, the applied field intensity could not be assessed as the inter-electrode gap was unknown. However as V∝P^{1/2}, the increment in field intensity should be proportional to the square root of the RF generator power. Electrical measurements on the different samples revealed an evident increase of 75-90% in specific electrical conductivity compared to the reference samples (0W), while there was no apparent change in the G/D ratios retrieved from Raman spectroscopy (see FIG. 13a). Moreover, the Raman profile pattern remained similar between all the samples (see FIG. 21). These findings indicate that the increase in electrical properties was not due to a shift in the synthesis process producing less defective CNTs but rather a transition in the microstructure leading to less resistive CNT-CNT junctions. Further mechanical analysis demonstrated a distinctive shift in the tensile behaviour of the samples, as seen by their stress/strain curves (see FIG. 13b). The CNT material produced by the original process (0W) shows a ductile behaviour with a high strain ratio to failure and a vague breakpoint. In comparison, all CNT materials produced under an AC field had a much more brittle-like behaviour with a lower strain ratio to failure and a clear failure point. Interestingly the in-situ aligned materials presented a dramatic increase in the elastic moduli (5) of up to 375% and specific tensile to failure (UTS) of up to 358%. This dramatic transformation in mechanical behaviour is reassuring evidence for changes in the load-bearing microstructure of the CNT network due to CNT alignment.

To get a direct evaluation of the degree of alignment, additional SAXS analysis was performed on the samples. FIG. 14a shows the overlaid azimuthal scans of the reference (0W) and 300 W samples normalized by the invariant (the scattering power) accompanied by the relevant 2D SAXS patterns. It can be clearly seen that while the reference sample does not show any orientation pattern (as it is inherently isotropic), the 300 W sample shows the distinctive Lorentzian type distribution associated with a more profound alignment pattern. Additional analysis based on raw data integration to calculate Herman's parameter (P₂) revealed a trend between the applied voltage (which correlates with the square root of the RF power) and the degree of alignment (see FIG. 14b). Also seen is a clear correlation between P₂ and δ, supporting the concept that the stiffness of the CNT network is governed dominantly by the internal alignment of its CNT bundles. Interestingly, apart from the P₂ values, the distribution of the azimuthal scans (as seen in the insets) develop for non-existent (0W), Gaussian-like (200, 250 W) to Lorentzian-like (300 W), supporting the notion that alignment is correlated to field intensity.

### CNT Alignment Using an RF Field—a Theoretical Model

Z-Pinch Stiffening

The CNT is modelled as a continuous shell with vanishing thickness. As a mean-field approximation, it was assumed that the current density within the CNT wall is constant along the entire CNT contour. The current in a CNT is limited by scattering of the electrons with optical phonons. Modelling of the current-carrying modes within an SWCNT suggests that electric currents for RF electric fields should exceed the maximum saturation current of a CNT wall of J₀≈25 μA. Hence, as current saturation is assumed, it is assumes that a SWCNT carries the saturation current J₀ when an RF AC field is applied. This contrasts with a simple DC field, where no current will flow after the initial polarization of the CNT. Furthermore experiments suggest that in bundles of SWCNTs and MWCNTs, each CNT wall carries its own saturation current. Hence the total current scales proportionally with the number of walls present in the CNT fibre.

The axial electric current in the CNT then induces a circumferential magnetic field within the CNT wall as shown in FIG. 15a. The magnitude of the field can be calculated using Ampere's law. The axial electric current subsequently experiences a Lorentz force due to the presence of the magnetic field. Effectively, this can be modelled as a pressure acting on the wall of the CNT. The name z-pinch refers to this “pinching” of the CNT about its vertical z-axis and is derived from the similar effect used to compress a plasma strongly enough to undergo nuclear fusion. While the effect is less drastic in a CNT, it can stiffen the CNT to facilitate alignment.

If a curved CNT segment is considered, it is clear that the side facing towards (away from) the centre of curvature is compressed (stretched). Hence there is more surface area for the Lorentz pressure to act on the side facing away from the centre of curvature, leading to an effective restoring force. As this force counteracts any curvature, the CNT is stiffened by the z-pinch effect. An illustration of the pressure and restoring force is shown in FIGS. 15b-c.

### Model Results

The main measure used to quantify alignment is the two-dimensional orientational order parameter T₂ defined by:

T₂=2 [symbol] cos θ_{2D} [symbol] −1

where θ_{2D} denotes the two-dimensional alignment angle of the CNT with the electric field. This quantity can be easily measured in two-dimensional SEM images of CNT materials, hence allowing for the direct comparison of the present theoretical model with experimental data. The mean value of T₂ varies along the CNT, being lowest at the CNT ends and highest at the mid-point of the CNT. As a conservative measure of CNT alignment, the minimum value T_{2,min} found at the CNT ends was chosen

### Rigid-Elastic Transition

Intuitively CNT alignment improves with increasing electric field strength and CNT length up to a certain point. For DC, there is a clear change in behaviour where T_{2,min} no longer depends on the CNT length above a threshold length (see FIG. 16a). This threshold length can be derived analytically and is proportional to the persistence length of CNTs. Below the threshold length, CNTs can be treated as rigid. Above the threshold length, elastic bending dominates the system, limiting the coupling of the CNT to the electric field. For AC, the rigid regime still exists, but for lower values of T_{2,min} and long CNTs, the behaviour deviates from the elastic regime and returns to the rigid regime (see FIG. 16b). This indicates that the z-pinch effect stiffens the CNTs (ie can effectively render them rigid). For SWCNTs that are substantially aligned, this effect only sets in at millimetre length scales (see FIG. 16c) and is limited by the relatively low value of the saturation current. However this result demonstrates that z-pinch stiffening can, in principle, facilitate alignment even for SWCNTs.

### SWCNT Bundles and MWCNTs

The strength of z-pinch stiffening is limited by current saturation in SWCNTs. However the saturation current scales proportionally to the number of CNT walls in a bundle of SWCNTs or single MWCNTs. Hence z-pinch stiffening should be significantly more pronounced in both cases. FIGS. 16d-e show the electric field strength E plotted against the CNT length L for different bundles of (10,10) SWCNTs and MWCNTs. For the plots, n=0.5 was chosen to represent a material with substantial alignment. Both plots contain a single (10,10) SWCNT for reference, where z-pinch stiffening only becomes dominant for millimetre length scales. Once around three CNT walls are present, either as individual SWCNTs in a bundle or as a wall of a MWCNT, which is the most dominant nanostructure in the aerogel (see FIG. 16f), z-pinch stiffening is already significant right at the rigid-elastic transition threshold length. Hence the z-pinch effect can effectively stiffen CNT structures containing upwards of three CNT walls, facilitating their electric field alignment. The electric field strength necessary for alignment then drops below the typical dielectric breakdown field strength of the FCCVD process gas, making the alignment of single MWCNTs and small-diameter SWCNT bundles technically feasible.

### Twin Electrode Configuration

As a means of controlling and increasing the applied field intensity and its lateral occurrence in the reactor volume, an additional two electrode setup (see FIG. 17a) was developed. The same graphite RF electrode as in the original setup, and a molybdenum electrode (the grounded electrode) was inserted through the back. Both electrodes were aligned along the central axis of the reactor tube and could freely move laterally. This configuration allowed each electrode position to be set separately and enabled adjustment of the inter-electrode position and gap width (ΔX and ΔL respectively as seen in FIG. 17a). Such means enabled control of the applied field intensity (in conjugation with the input power of the RF supply) and the lateral location of the inter-electrode gap. It was evident that the system can achieve HV by creating a hydrogen breakdown between the two electrodes, a phenomenon that requires field intensities in the order of at least several kV cm⁻¹ for a hydrogen atmosphere (FIG. 17bi). A visual indication coinciding well with the field distribution model was evident when the inter-electrode gap was positioned in the VGCF growth regime. In that configuration, when the precursors were injected and HV was on, it was clearly seen that whiskers grew between the electrodes (FIG. 17bii). Most notably seen were the central field line and the peripherals tangential to the electrode ends.

Due to the rapid radial growth of VGCF whiskers on the RF electrode and the inevitable HV setup going off-tune leading to a massive drop in voltage and field intensity even for a short period (^{˜}5 s) of applied HV, it was apparent that the setup has a substantial influence on the formation and alignment of the CNT aerogel. This can be easily inferred from FIG. 17d which compares the micromorphology of a reference sample (top), revealing its isotropic nature to a material synthesized under the influence of a ^{˜}0.75 kV cm⁻¹ in-situ electric field (bottom) appearing remarkably aligned. As the CNT bundles were well aligned, it was possible to trace some individual ones running along with the whole frame, making it discernible that some bundles were at least 50 μm long and even more than 100 μm in other cases (see FIG. 22). After running a substantial number of experimental setups with various ΔX and ΔL configurations, it was evident that CNT alignment is achieved only if the grounded electrode was positioned at least 140 mm downstream to the furnace's midpoint. This result coincides nicely with knowledge that most of the CNT aerogel is synthesized at the last third part of the reactor.

As the amount of material produced in the twin-electrode setup was meagre, quantifying the degree of alignment as a function of the applied field intensity could only be done through SEM image analysis. An open-access program (Fibre COP) dedicated to quantifying the uniaxial orientational order based on 2D images was used to accommodate such a need. For orientational distributions derived from 2D images, the software computed the average of the second moment of the Chebyshev (as opposed to Legendre) polynomial according to a Lorentzian fibre orientation distribution. Thus the calculated orientational order parameter is referred to in this section as T₂ rather than the more common Herman's parameter (P₂), which is suitable for data derived from a ‘3D bulk sample, for example obtained from x-ray diffraction. It was also noted that T₂ values based on a Lorentzian distribution always show lower values than P₂ on the same dataset. Hence one should not directly compare present values of T₂ to Herman's parameters published elsewhere, but instead use it as an internal scale of alignment. As shown in FIG. 18a, the reference sample (0 kV cm⁻¹) is visually isotropic. However it does exhibit a T₂ of 0.19 (full isotropy should lead to a value of zero). That can be related to some inherent orientation in the material due to the associated gas flow in the reactor. Setting the system with an applied field intensity of 0.23 kV cm⁻¹ seems not to change the fundamental isotropic nature of the CNT aerogel, leaving the orientation parameter without an actual change at 0.20. Only when the field intensity was altered to 0.30-0.35 kV cm¹ was a noticeable CNT alignment pattern revealed. While a portion of the CNT bundles did not follow the horizontal pattern, a vast fraction did, and as a result, increased the T₂ value to 0.41-0.42. When the field intensity was increased to 0.75-0.95 kV cm⁻¹ a very distinctive aligned pattern was noticed. Image analysis revealed that the orientation parameter leaped to 0.46-0.51 which was found to be very similar to values calculated from SEM images taken from commercial CNT fibres (5 tex; Tortech Nano Fibres Ltd.). While orientation parameters follow a non-linear trend, an increase in T₂ from ^{˜}0.2 to ^{˜}0.5 is equivalent to a reduction from ^{˜}100 to ^{˜}43.5° in the full-width-at-half-maximum (FWHM) and as such should be considered significant. There seems to be an order of magnitude discrepancy between the experimental applied field intensity and the one to reach a T₂ of ^{˜}0.5 (FIG. 16d) but the presence of the field enhancement effect that is dominant in the case of 1D nanomaterials such as CNTs. As a first order approximation this enhancement factor is proportional to the aspect ratio of the 1D material and in the current case it should be ≥500 according to a higher order approximation. Another change observed in the material's micromorphology was associated with the CNT bundle diameter. As shown in FIG. 18b, the higher the field intensity employed in the inter-electrode gap, the thicker the CNT bundles became. The CNT median diameters were analysed to be 16.44, 18.87 and 25.40 nm for field intensities of 0.23, 0.35 and 0.75 kV cm⁻¹ respectively. It was expected that the CNT bundles would become thinner due to the aligning forces, as less collisions should occur between adjacent CNTs. This counter-intuitive phenomenon could be explained due to the presence of compressive Lorentzian pinch induced on the CNTs as a result of the AC field.

### CONCLUSIONS

This novel approach utilizes external electrical fields (eg up to an intensity of ^{˜}1 kV cm⁻¹) to form a substantial effect on the self-assembly mechanism of CNTs in the gas phase, as manifested by apparent CNT bundle thickening from ^{˜}16 to ^{˜}25 nm. The system enables the continuous in-situ manipulation of the nanomaterials whilst being collected to form macroscopic textiles. As determined by SAXS, the method has proven to generate distinctive alignment patterns compared to the isotropic nature of the original bulk material. The microstructural reorganization correlates nicely with the transition of the textile's mechanical behaviour from ductile to brittle-like, increasing the elastic moduli by up to 375%. As the alignment led to a higher portion of load-bearing nanotubes resisting tensile load, the specific stress to failure increased by up to 358%. This also led to fewer resistive CNT-CNT junctions with an associated electrical enhancement of up to 90%. Interestingly the electric field did not influence the CNT synthesis as no apparent changes could be detected using Raman spectroscopy. A well-developed model acknowledged the feasibility of MWCNT bundle alignment to occur below the carrier gas breakdown threshold and revealed the benefits of applying an AC rather than a DC field.

There is confidence that this novel use of external fields to manipulate and control the assembly process of CNT networks in the gas phase will unlock the full potential of high aspect ratio (^{˜}10⁴) CNT-based textiles without sacrificing the cost-effectiveness of the basic process.

1. A method for the production of a carbon nanotube structure comprising:
(a) introducing a metal catalyst precursor into a continuous flow of a carrier gas in a temperature-controlled flow-through reactor;
(b) exposing the metal catalyst precursor in the flow of the carrier gas to a first temperature zone sufficient to generate particulate metal catalyst;
(c) releasing a source of carbon into the flow of the carrier gas;
(d) exposing the particulate metal catalyst and the source of carbon to a second temperature zone downstream from the first temperature zone, wherein the second temperature zone is sufficient to produce a carbon nanotube aggregate;
(e) generating an electric field in the temperature-controlled flow-through reactor at or near to the second temperature zone;
(f) discharging the carbon nanotube aggregate as a continuous discharge through a discharge outlet of the temperature-controlled flow-through reactor; and
(g) collecting the continuous discharge in the form of a carbon nanotube structure.

2. The method as claimed in claim 1 wherein the electric field is oriented substantially parallel to the flow path of the carrier gas.

3. The method as claimed in claim 1 wherein the electric field is oriented substantially coaxial with the flow path of the carrier gas.

4. The method as claimed in claim 1 wherein the electric field is generated by an AC source.

5. The method as claimed in claim 1 wherein the electric field is generated at a field intensity in the range 0.35 to 1.0 kV cm-1.

6. The method as claimed in claim 1 wherein the temperature-controlled flow-through reactor comprises:
an elongate refractory housing extending from an upstream end to a downstream end into which the metal catalyst precursor is introduced in step (a) and the source of carbon is released in step (c);
a thermal enclosure surrounding the elongate refractory housing which is adapted to provide an axial temperature variation between temperature zones in the elongate refractory housing, wherein the temperature zones include the first temperature zone and the second temperature zone; and
an electrode positioned inside or outside the elongate refractory housing.

7. The method as claimed in claim 6 wherein the electrode is oriented substantially parallel to the flow path of the carrier gas.

8. The method as claimed in claim 6 wherein the electrode is oriented substantially coaxial with the flow path of the carrier gas.

9. The method as claimed in claim 1 wherein the carbon nanotube aggregate is an aerogel.

10. A temperature-controlled flow-through reactor for the production of a carbon nanotube structure comprising:
an elongate refractory housing extending from an upstream end to a downstream end;
an inlet at or near to the upstream end of the elongate refractory housing for introducing a continuous flow of a carrier gas from the upstream end to and beyond the downstream end;
a first feed for releasing a source of carbon into the continuous flow of the carrier gas;
a second feed for introducing a metal catalyst precursor into the continuous flow of the carrier gas;
a thermal enclosure surrounding the elongate refractory housing which is adapted to provide an axial temperature variation between temperature zones in the elongate refractory housing, wherein the temperature zones include a first temperature zone sufficient to generate particulate metal catalyst and a second temperature zone sufficient to produce a carbon nanotube aggregate;
a collector for collecting from the downstream end a continuous discharge of the carbon nanotube aggregate in the form of a carbon nanotube structure;
a first electrode positioned inside or outside the elongate refractory housing; and
an electric field generator electrically connected to the first electrode so as to apply a high potential thereto which is sufficient to generate an electric field in the elongate refractory housing at or near to the second temperature zone.

11. The temperature-controlled flow-through reactor as claimed in claim 10 further comprising a second electrode.

12. The temperature-controlled flow-through reactor as claimed in claim 10 wherein the electric field is substantially coaxial with the elongate refractory housing.

13. The temperature-controlled flow-through reactor as claimed in claim 10 wherein the collector is electrically connected to ground.

14. The temperature-controlled flow-through reactor as claimed in claim 10 wherein the first electrode is positioned inside the elongate refractory housing at or adjacent to the second temperature zone and the collector is connected electrically to ground.

15. The temperature-controlled flow-through reactor as claimed in claim 10 further comprising a second electrode outside the elongate refractory housing, wherein the first electrode is positioned inside the elongate refractory housing at or adjacent to the second temperature zone.

16. The temperature-controlled flow-through reactor as claimed in claim 15 wherein the second electrode is electrically connected to the thermal enclosure and the thermal enclosure is grounded.

17. The temperature-controlled flow-through reactor as claimed in claim 10 wherein the first electrode is positioned outside the elongate refractory housing adjacent to the second temperature zone.

18. The temperature-controlled flow-through reactor as claimed in claim 10 further comprising a second electrode positioned outside the elongate refractory housing, wherein the first electrode is positioned outside the elongate refractory housing and the second electrode is electrically connected to ground.

19. The temperature-controlled flow-through reactor as claimed in claim 10 wherein the electric field generator is an AC source.

20. The temperature-controlled flow-through reactor as claimed in claim 19 wherein the electric field generator is operable at high radio-frequency (HF).

21. The temperature-controlled flow-through reactor as claimed in claim 10, wherein the carbon nanotube aggregate or carbon nanotube structure comprises carbon nanotube bundles with a median diameter of 16 nm or more.

22. The temperature-controlled flow-through reactor as claimed in claim 21, wherein the diameter of the carbon nanotube bundles follows a log normal distribution.

23. A carbon nanotube aggregate or carbon nanotube structure which comprises carbon nanotube bundles with a median diameter which is variable axially along the carbon nanotube aggregate or carbon nanotube structure.

24. The temperature-controlled flow-through reactor as claimed in claim 23 wherein the diameter of the carbon nanotube bundles varies axially from a normal distribution to a log normal distribution.
